(19) United States
(12) Patent Application Publication
(10) Pub. No.: US 2024/0385406 A1
(43) Pub. Date: Nov. 21, 2024

(54) HINGED MODULAR SPLICE TRAY SYSTEMS FOR CLOSURES

(71) Applicants: Tyler CLAS, Duncan, SC (US); David WITTMEIER, Duncan, SC (US); AFL Telecommunications LLC, Duncan, SC (US)

(72) Inventors: Tyler Clas, Greer, SC (US); David Wittmeier, Greer, SC (US)

(21) Appl. No.: 18/692,357

(22) PCT Filed: Sep. 13, 2022
(86) PCT No.: PCT/US2022/043317

§ 371 Date: Mar. 15, 2024

Related U.S. Application Data
(60) Provisional application No. 63/306,275, filed on Feb. 3, 2022.
(60) Provisional application No. 63/245,775, filed on Sep. 17, 2021.

(51) Int. Cl. G02B 6/44

(52) U.S. Cl. CPC G02B 6/44524

(57) ABSTRACT

A fiber optic closure including a spine, a platform, and a tray assembly is provided. The spine is extending along a vertical axis and forms a first wall extending along a transverse axis. The spine forms a second wall extending along a lateral axis. The platform is releasably attachable to the spine at the second wall. The platform is configured to extend in a first position alongside the second wall along the vertical axis. The platform is configured to extend in a second position at an angle from second wall between the vertical axis and the transverse axis. The tray assembly is releasably attachable to the first wall of the spine.

### PRIORITY STATEMENT

This application claims the benefit of priority to U.S. Provisional Patent Application Ser. No. 63/245,775, filed Sep. 17, 2021, and to U.S. Provisional Patent Application Ser. No. 63/306,275, filed Feb. 3, 2022, each of which are incorporated by reference herein in their entireties.

### FIELD

The present disclosure relates generally to fiber optic closures.

### BACKGROUND

In many metropolitan areas, fiber optic closures are kept underground, such as in handholes, so that the fiber optic closures cannot be seen or disrupted by members of the public. The fiber optic closures are used to hold all of the fiber optic splices that are needed to connect data from a source cable to individual fiber optic lines. Some places or users require large quantities of relatively small splice trays to accomplish large-quantity splices in the fiber optic closure, in contrast to small quantities of relatively large splice trays.

The fiber optic closures are secured in various ways in the handholes. In some instances, the fiber optic closure is placed on the ground within the handhole. In other instances, the fiber optic closure is attached to a pole, a rail, or other member within the handhole. Generally, the fiber optic closure is placed, attached, or secured within the handhole in a variety of ways or methods.

Furthermore, known methods and structures may fix the fiber optic closure within the handhole and inhibit articulation of the fiber optic closure within or out of the handhole. Known structures and methods may additionally inhibit placement of the fiber optic closure at a height or location that facilitates maintenance, assembly, disassembly, or operation at the fiber optic structure by a person.

Accordingly, there is a need for structures that allows for holding, supporting, and organizing large quantities of splice trays within a fiber optic closure. Additionally, there is a need for structures that provide for articulation of the fiber optic closure within or out of a handhole. Still further, there is a need for structures that place a fiber optic closure at a height or location that facilitates operation at the fiber optic structure by a person.

### BRIEF DESCRIPTION

Aspects and advantages of the invention in accordance with the present disclosure will be set forth in part in the following description, or may be obvious from the description, or may be learned through practice of the technology.

An aspect of the present disclosure is directed to a fiber optic closure including a spine, a platform, and a tray assembly. The spine is extending along a vertical axis and forms a first wall extending along a transverse axis. The spine forms a second wall extending along a lateral axis. The platform is releasably attachable to the spine at the second wall. The platform is configured to extend in a first position alongside the second wall along the vertical axis. The platform is configured to extend in a second position at an angle from second wall between the vertical axis and the transverse axis. The tray assembly is releasably attachable to the first wall of the spine.

Another aspect of the present disclosure is directed to a fiber optic closure including a spine, a platform, and a plurality of tray assemblies. The spine is extending along a vertical axis and forms a first wall extending along a transverse axis. The first wall includes a first face and a second face each extending along the transverse axis and the vertical axis. The first face and the second face are each positioned opposite of one another along a lateral axis. The spine forms a second wall extending along the lateral axis. The second wall includes a third face and a fourth face each extending along the lateral axis and the vertical axis. The third face and the fourth face are each positioned opposite of one another along the transverse axis. The platform is releasably attachable to the spine at each of the third face and the fourth face. The platform is configured to extend in a first position alongside the second wall along the vertical axis. The platform is configured to extend in a second position at an angle from second wall between the vertical axis and the transverse axis. The plurality of tray assemblies is releasably attachable to the first face and the second face of the spine. The plurality of tray assemblies is attachable to the spine in adjacent arrangement along the vertical axis at the first face and the second face. Each tray assembly includes a tray panel extending along the vertical axis when attached to the spine. The plurality of tray plates is releasably attachable to the tray panel.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 depicts a perspective view of an embodiment of a fiber optic closure in accordance with aspects of the present disclosure;

FIG. 2 depicts a perspective view of an embodiment of a fiber optic closure in a first closed position accordance with aspects of the present disclosure;

FIG. 3 depicts a perspective view of an embodiment of a fiber optic closure in a second open position in accordance with aspects of the present disclosure;

FIG. 4 depicts a perspective view of an embodiment of a fiber optic closure in accordance with aspects of the present disclosure;

FIG. 5 depicts a perspective view of a partially disassembled embodiment of a fiber optic closure in accordance with aspects of the present disclosure;

FIG. 6 depicts a perspective view of an embodiment of a fiber optic closure in accordance with aspects of the present disclosure;

FIG. 7 depicts a perspective view of an embodiment of a fiber optic closure in accordance with aspects of the present disclosure;

FIG. 8 depicts a perspective view of an embodiment of a fiber optic closure in accordance with aspects of the present disclosure;

FIG. 9 depicts a view along a lateral axis of an embodiment of a fiber optic closure in accordance with aspects of the present disclosure;

FIG. 10 depicts a view along a lateral axis of an embodiment of a fiber optic closure in accordance with aspects of the present disclosure;

FIG. 11 depicts a perspective view of an embodiment of a fiber optic closure in accordance with aspects of the present disclosure;

FIG. 12 depicts a perspective view of an embodiment of a fiber optic closure in accordance with aspects of the present disclosure;

FIG. 13 depicts a perspective view of an embodiment of a fiber optic closure in accordance with aspects of the present disclosure;

FIG. 14 depicts a perspective view of an embodiment of a fiber optic closure in accordance with aspects of the present disclosure;

FIG. 15 depicts a perspective view of an embodiment of a fiber optic closure in accordance with aspects of the present disclosure;

FIG. 16 depicts a perspective view of an embodiment of a portion of a tray assembly of a fiber optic closure in accordance with aspects of the present disclosure;

FIG. 17A depicts steps of a method for assembling a tray plate to a tray panel of a tray assembly in accordance with aspects of the present disclosure;

FIG. 17B depicts steps of a method for assembling a tray plate to a tray panel of a tray assembly in accordance with aspects of the present disclosure;

FIG. 17C depicts steps of a method for assembling a tray plate to a tray panel of a tray assembly in accordance with aspects of the present disclosure;

FIG. 18A depicts a perspective view of an embodiment of a portion of a tray assembly of a fiber optic closure in accordance with aspects of the present disclosure;

FIG. 18B depicts a perspective view of an embodiment of a portion of a tray assembly of a fiber optic closure in accordance with aspects of the present disclosure;

FIG. 19A depicts a perspective view of an embodiment of a portion of a tray assembly of a fiber optic closure in accordance with aspects of the present disclosure;

FIG. 19B depicts a perspective view of an embodiment of a portion of a tray assembly of a fiber optic closure in accordance with aspects of the present disclosure;

FIG. 20 depicts a perspective view of an embodiment of a portion of a tray assembly of a fiber optic closure in accordance with aspects of the present disclosure;

FIG. 21 depicts a view of an embodiment of a tray assembly of a fiber optic closure in accordance with aspects of the present disclosure;

FIG. 22 depicts a view of an embodiment of a tray assembly of a fiber optic closure in accordance with aspects of the present disclosure;

FIG. 23A depicts a perspective view of an embodiment of a portion of a stackable tray plate assembly of a fiber optic closure in accordance with aspects of the present disclosure;

FIG. 23B depicts a perspective view of an embodiment of a portion of a stackable tray plate assembly of a fiber optic closure in accordance with aspects of the present disclosure;

FIG. 23C depicts a side view of an embodiment of a portion of a stackable tray plate assembly of a fiber optic closure in accordance with aspects of the present disclosure;

FIG. 24A depicts a perspective view of an embodiment of a portion of a stackable tray plate assembly of a fiber optic closure in accordance with aspects of the present disclosure;

FIG. 24B depicts an exploded perspective view of an embodiment of a portion of a stackable tray plate assembly of a fiber optic closure in accordance with aspects of the present disclosure;

FIG. 25 depicts a side cross sectional view of an embodiment of a portion of a stackable tray plate assembly of a fiber optic closure in accordance with aspects of the present disclosure;

FIG. 26 depicts a perspective view of an embodiment of a fiber optic closure in accordance with aspects of the present disclosure;

FIG. 27 depicts a perspective view of an embodiment of a fiber optic closure in accordance with aspects of the present disclosure;

FIG. 28 depicts a top-down perspective view of an embodiment of a fiber optic closure in an open position accordance with aspects of the present disclosure;

FIG. 29 depicts a side view of an embodiment of a fiber optic closure in an open position accordance with aspects of the present disclosure;

FIG. 30 depicts a top-down perspective view of an embodiment of a fiber optic closure in an open position accordance with aspects of the present disclosure;

FIG. 31 depicts a perspective view of an embodiment of a fiber optic closure in accordance with aspects of the present disclosure;

FIG. 32 depicts a perspective view of an embodiment of a fiber optic closure in accordance with aspects of the present disclosure;

FIG. 33 depicts a top-down view of an embodiment of a fiber optic closure in accordance with aspects of the present disclosure;

FIG. 34 depicts a perspective view of an embodiment of a mount structure for a fiber optic closure in accordance with aspects of the present disclosure;

FIG. 35A illustrates an exemplary operation of the mount structure in accordance with aspects of the present disclosure; and

FIG. 35B illustrates an exemplary operation of the mount structure in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive—or and not to an exclusive—or. For example, a condition A or B is satisfied by any one of the following: A is true (or present) and B is false (or not present), A is false (or not present) and B is true (or present), and both A and B are true (or present).

Ranges provided herein are inclusive of their end points. For instance, a range of 1 to 100 includes 1 and 100.

Terms of approximation, such as “about,” “generally,” “approximately,” or “substantially,” include values within a ten percent full scale error from a lowest value embodiment to a highest value embodiment. For instance, an embodiment including a range from approximately 10 to approximately 100 with a ten percent full scale error may include values from 1 to 109.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Embodiments of a fiber optic closure are provided. The fiber optic closure includes a structural frame or spine configured to hold and support optical fibers, tubes, cables, leads, and splice or splitter trays. Fiber optic cables route through a base. The base may further provide environmental sealing, such as air and moisture sealing. The spine extends along a vertical axis from the base. The spine includes a releasably attachable, or detachable, platform, such as at a first wall forming a front face and a second wall forming a rear face. Mounting features at the spine, such as a tray retention member, may further allow a tray assembly to be releasably attached to the spine. A plurality of tray assemblies is attachable to the spine in vertical arrangement, such as along a vertical track formed at each of the first wall and the second wall. Each tray assembly includes a plurality of the splice or splitter trays, or tray plates, positionable in vertical arrangement along the spine. The spine includes storage features, such as spools and tabs, for retaining, routing, holding, or otherwise securing loose or excess fibers, cables, or tubes. Particular embodiments of the fiber optic closure include the storage features at the platform, at a routing panel attachable to the spine, at a tube holder attachable to the routing panel, at an upper routing guide, or at the spine. A hinge interface at the platform and the spine allows the platform to pivot along an angle or arc from the vertical axis, such as to the transverse axis or an oblique angle between the vertical axis and the transverse axis. A flexible member, such as a retention strap, is attached to the spine and the rotatable platform, such as to desirably limit the arc of pivot of the platform from the spine.

Various embodiments of the fiber optic closure may be constructed of any suitable material, including, but not limited to, plastic. Particular embodiments may construct the fiber optic closure substantially entirely out of one or more plastic materials. Still particular embodiments may construct the spine, the platform, the routing panel, the tube holder, and the upper routing guide as separately attachable monolithic bodies, allowing for relatively simple construction, assembly and disassembly, and customization for desired varieties of leads, tubes, fibers, splices, and combinations thereof.

Embodiments of the fiber optic closure and the mount structure provided herein may provide advantages such as holding up to 1728 or more individual splices within a single closure, while facilitating routing, splicing, and maintenance of the closure, and articulation of the closure into and out of an enclosed volume.

Embodiments of the mount structure provided herein allow for universal and standardized placement, attachment, and securing of the fiber optic closure in an enclosed volume, such as an underground volume, confined space, or handhole. Embodiments provided herein may allow for articulation of the fiber optic closure within or out of the enclosed volume. Additionally, or alternatively, embodiments of the mount structure provided herein allow for the fiber optic closure to be placed at a height or location that facilitates operation at the fiber optic closure by a person. Embodiments provided herein may facilitate ergonomic placement, provide improved articulation and adjustment of the fiber optic closure, and allow for attachment of the mount structure to various types of fiber optic closures and mount interfaces.

Methods for mounting a fiber optic closure include attaching the first bracket to the rail assembly proximate to a pivot member of the rail assembly. A mount plate attaches to the fiber optic closure via one or more mechanical fasteners. The mount plate is coupled to the first bracket via an arm. The arm positions the plate and the fiber optic closure substantially parallel or co-directional to the rail, such as by forming the arm with one or more portions extended along a radial direction from the first bracket. In certain embodiments, the arm is separable from the first bracket to allow for rotation of the arm, plate, and the fiber optic closure together relative to the first bracket.

In some embodiments, the fiber optic closure may be cantilevered from the first bracket via the arm and the mount plate. In other embodiments, the mount structure further includes the second bracket attached to the rail assembly and attached to the fiber optic closure via a mechanical compression device or clamp. The mount structure may accordingly allow for forward and rearward support of the fiber optic closure. The mount structure may furthermore support the fiber optic closure while orienting the fiber optic closure substantially parallel to the rail, allowing for reduced volume usage within the enclosed volume. The second bracket may include adjustable clamping features such as may be included at the first bracket to allow for attachment to various cross-sectional areas of the rail assembly.

Embodiments of the mount structure allow for movement, translation, articulation, or rotation of the rail assembly, such as rotation from a horizontal position (e.g., approximately zero degrees or parallel to the ground) to a vertical position (e.g., approximately 90 degrees or perpendicular to the ground). Additionally, or alternatively, the separable arm from the first bracket may allow the mount structure to be articulated to the vertical position. The mount structure may further include a removable pin, bolt, camlock, clamp, mechanical stop, or other detent extendable through the rail and the first bracket. Removing the detent allows for the first bracket, separately from or together with the fiber optic closure, to be translated along the rail to position the fiber optic closure at a desired height. The detent may be re-insertable at various portions of the rail to fix the fiber optic closure at the desired height, allowing for a person to perform maintenance, assembly, disassembly, splicing, or other operations at the fiber optic closure from a desired height, such as may be more ergonomic for the operator. Additionally, or alternatively, the detent and translation of the first bracket may allow for the fiber optic closure to be stored within a relatively smaller enclosed volume and/or on a shorter rail assembly while allowing the fiber optic closure to be re-positioned or translated to a desired operating height.

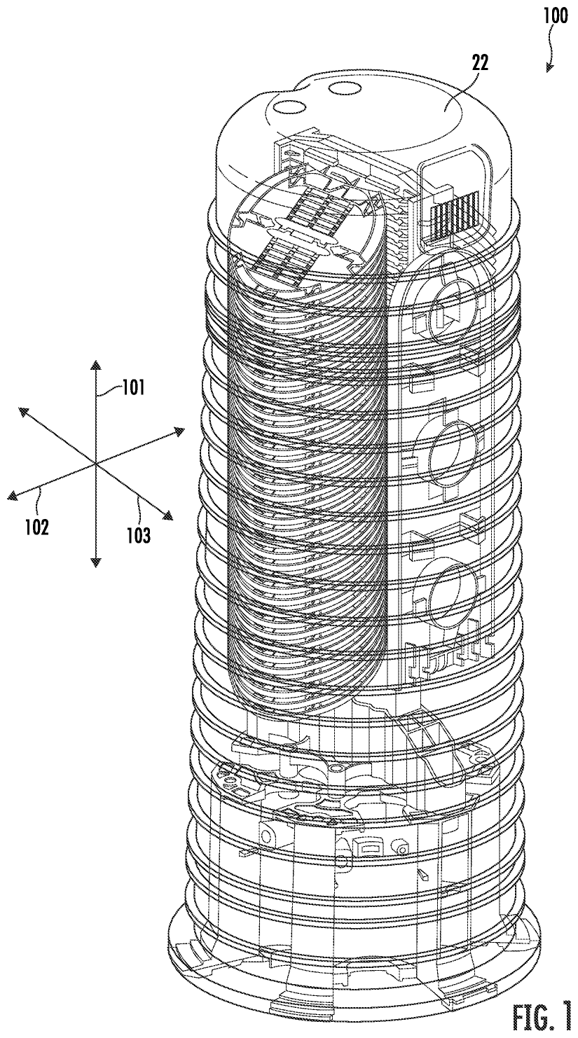

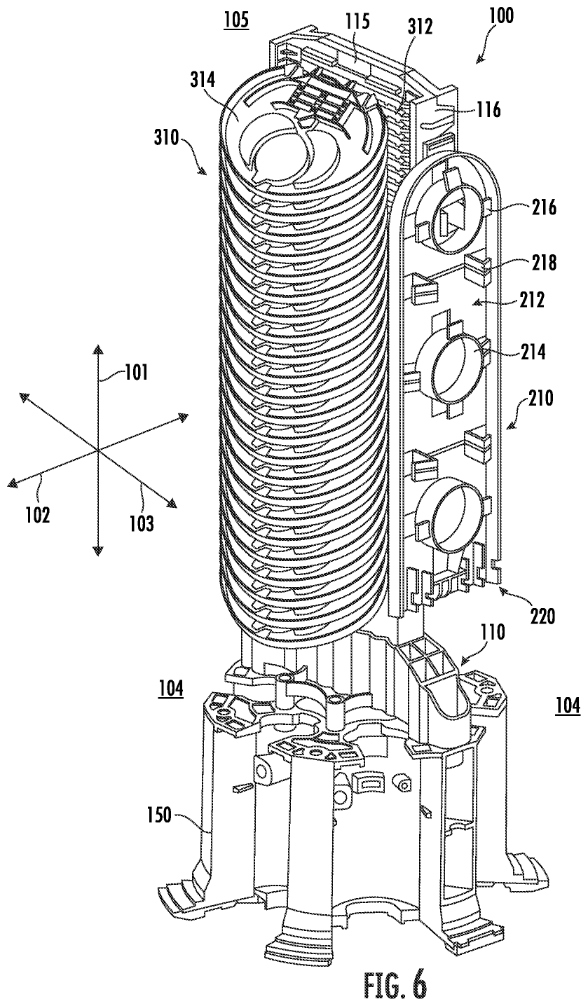

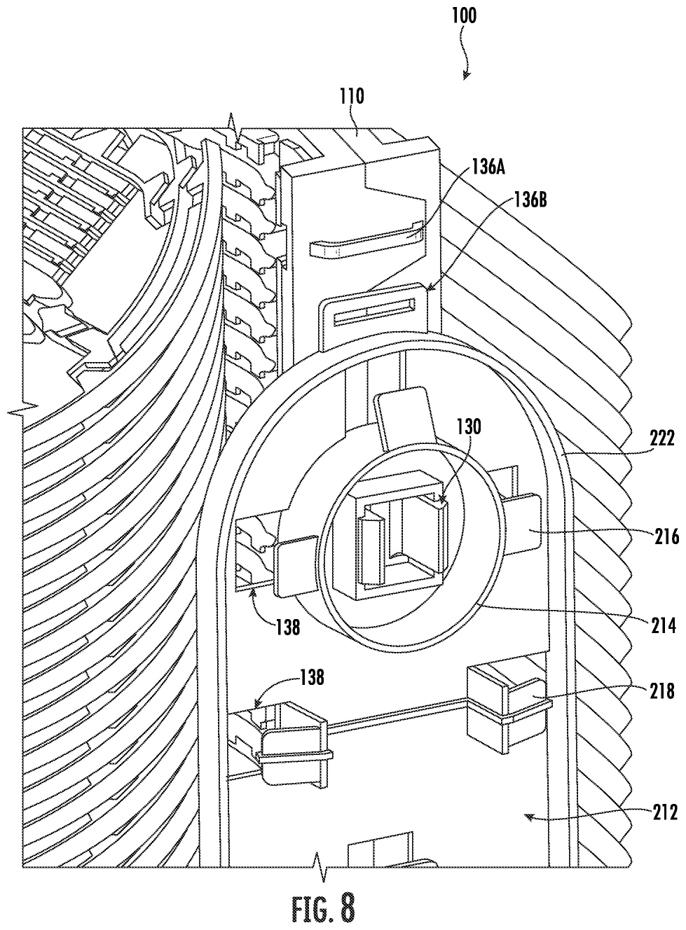

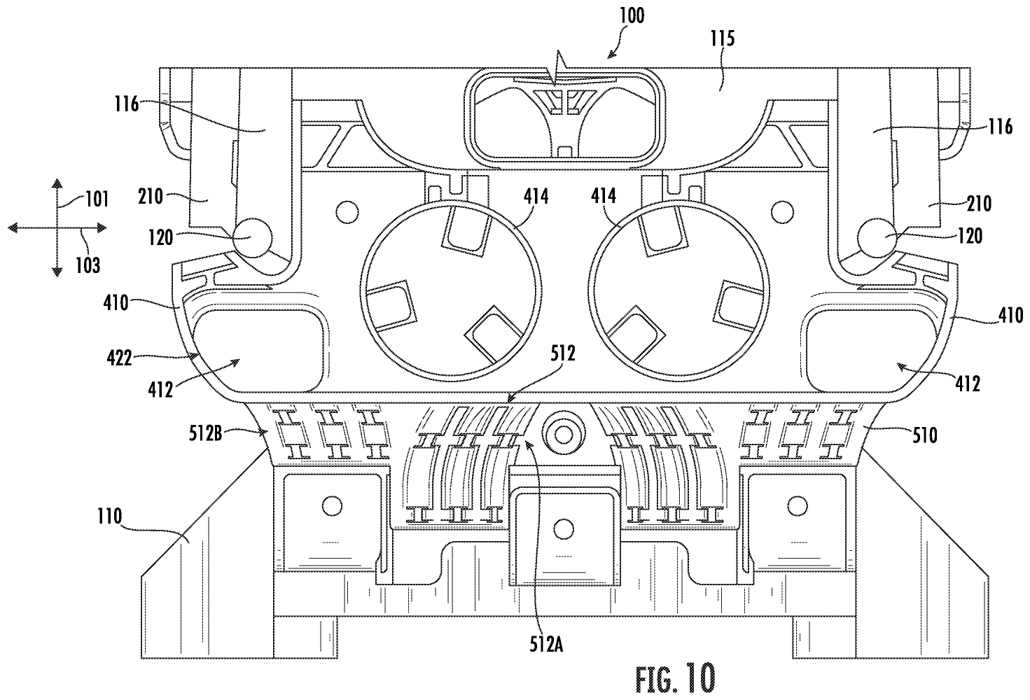

Referring now to the drawings, FIGS. 1-15 depict exemplary embodiments of a fiber optic closure 100, and portions thereof. A reference coordinate system defines a mutually orthogonal vertical axis 101, lateral axis 102, and transverse axis 103. A reference first end 104 is defined along the vertical axis 101 proximate to an end from which tubing, fibers, or cables (hereinafter, “leads”) enter the closure 100 from an external source. A reference second end 105 is defined along the vertical axis 101 distal to the first end 104. FIG. 1 depicts the closure 100 including a removable casing 22 surrounding a base 150, spine 110, rotatable platforms 210, and tray assemblies 310, such as further depicted and described herein. The casing 22 is attachable to the base 150, such as to seal the inside of the casing 22 from an outside environment. The first end 104 may particularly reference an end of the spine 110 proximate to the base 150 and the second end 105 may particularly reference an end of the spine 110 distal to the base 150.

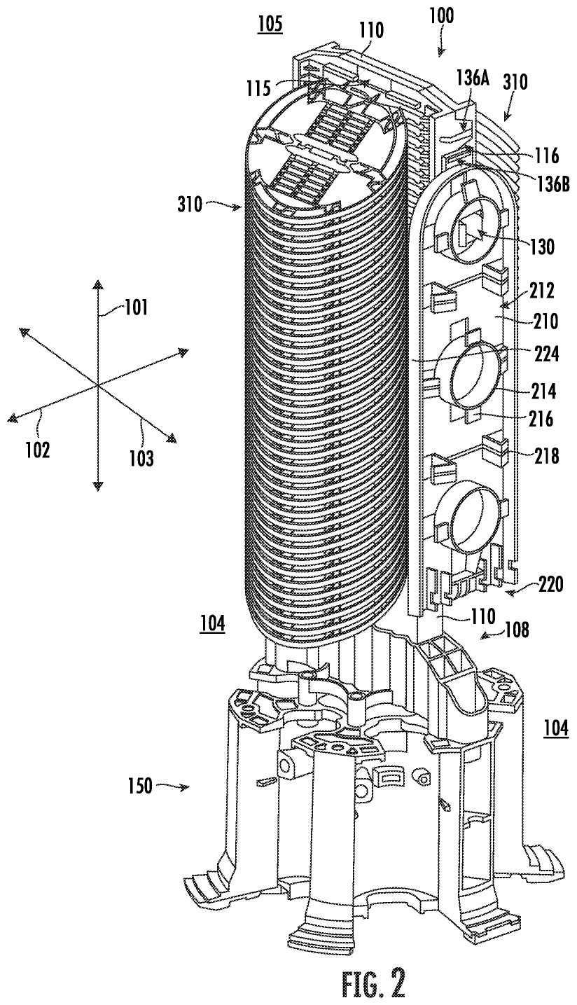

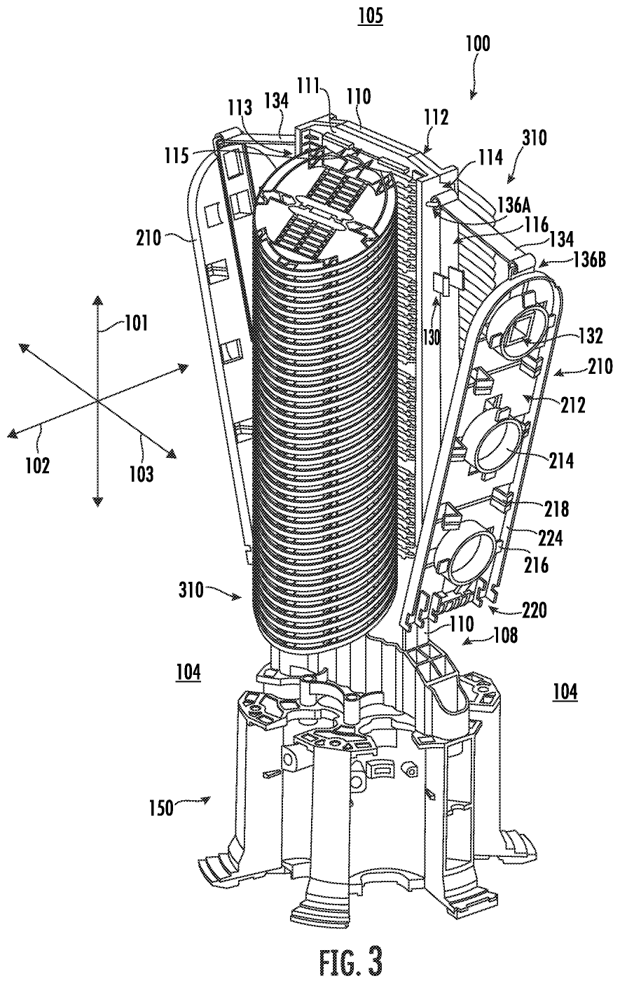

FIGS. 2-8 depict perspective views of the closure 100, and portions thereof, with the casing 22 removed. The closure 100 includes a spine 110 extending along the vertical axis 101. The spine forms a first wall 115 extending along the transverse axis 103. The spine forms a second wall 116 extending along the lateral axis 102. A rotatable platform 210 extends along the vertical axis 101 when in a first position. The platform 210 is releasably attachable to, or detachable from, the spine 110 at the second wall 116. The platform 210 is configured to extend in the first position alongside the second wall 116 along the vertical axis 101, such as depicted in FIG. 2 and FIGS. 6-8. The platform 210 is configured to extend in a second position at an arc or angle from second wall 116 between the vertical axis 101 and the transverse axis 103, such as depicted in FIGS. 3-5.

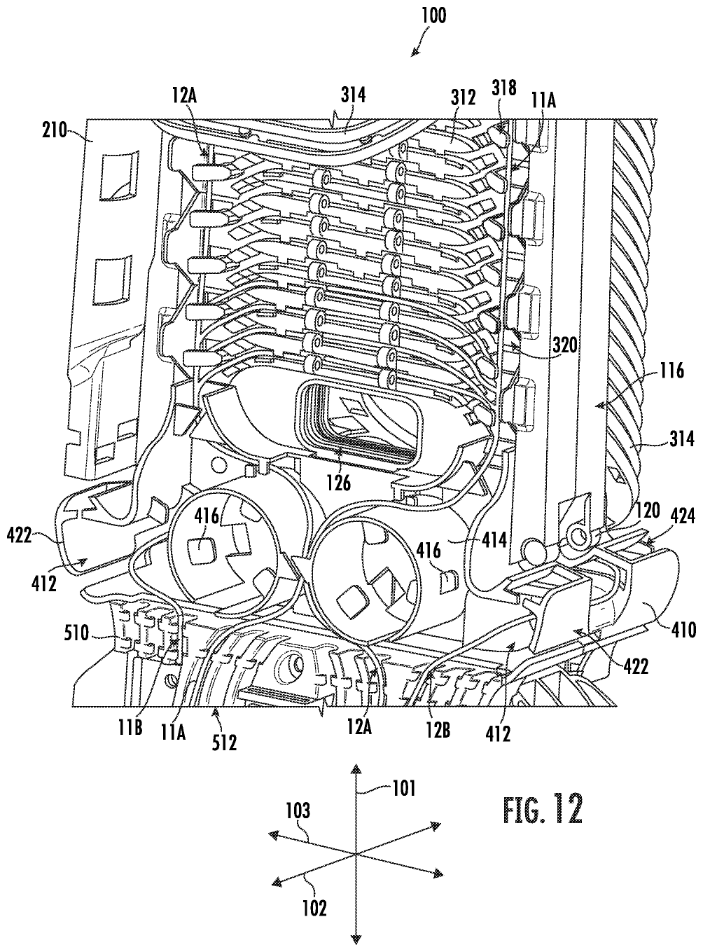

In a particular embodiment, the first wall 115 includes a first face 111 and a second face 112 each extending along the transverse axis 103. The first face 111 and the second face 112 are positioned opposite of one another along the lateral axis 102. In a still particular embodiment, the second wall 116 includes a third face 113 and a fourth face 114 each extending along the lateral axis 102. The third face 113 and the fourth face 114 are positioned opposite of one another along the transverse axis 103. The second wall 116, or particularly the third face 113 and the fourth face 114, is extended along the lateral axis 102 from the first wall 115. The first wall 115, or particularly the first face 111 and the second face 112, is extended along the transverse axis 103 between the third face 113 and the fourth face 114. The closure 100 includes a pair of platforms 210 each releasably attached to respective second walls 116 spaced apart along the transverse axis 103. FIG. 12 depicts a perspective view of an embodiment of the closure 100 with one of the pair of platforms 210 removed and with a plurality of tray plates 314 removed. In particular, the pair of platforms 210 is each detachably coupled to the third face 113 and the fourth face 114, respectively. Each platform 210 is rotatable from the first position (e.g., depicted in FIG. 2) substantially adjacent or co-directional to the vertical axis 101 and outward to the second position (e.g., depicted in FIG. 3) at an arc or angle between the vertical axis 101 and the transverse axis 103.

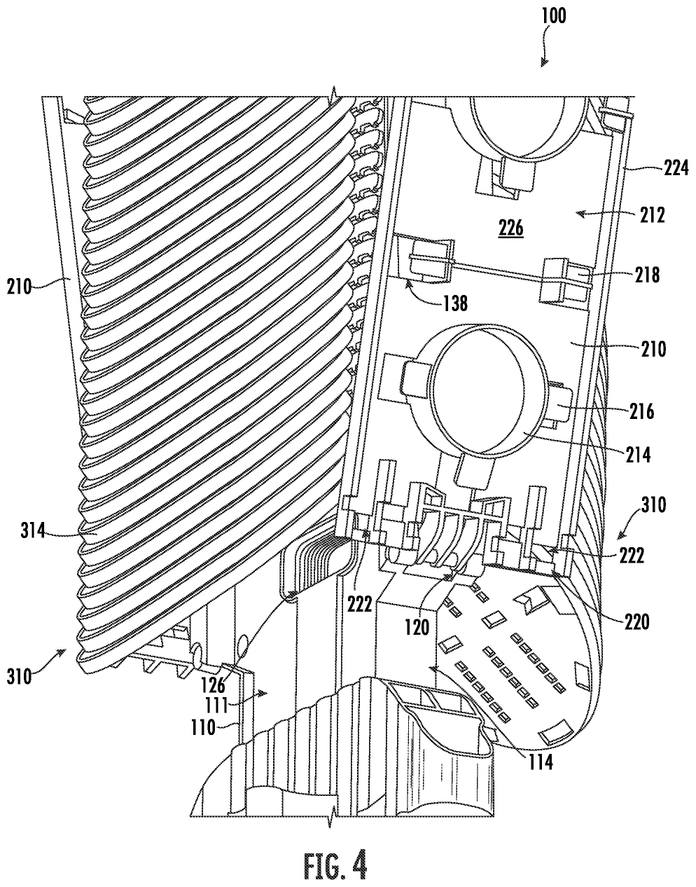

In various embodiments, such as particularly depicted in FIG. 4, a hinge interface 120 rotatably couples the platform 210 to the spine 110 at the second wall 116. In other embodiments (not depicted), a separately formed hinge assembly may be connected to the spine 110, and the platform 210 connects to the hinge assembly. In certain embodiments, the platform 210 and the spine 110 together form the hinge interface 120 at which the platform 210 is rotatably coupled to the spine 110. In a particular embodiment, the hinge interface 120 is positioned at the second wall 116 at or proximate to the first end 104. In certain configurations, the hinge interface 120 is rigid such that no retainer, strap, or tensioner is required to secure the platform in the second position such as described herein. However, in other embodiments, such as described below, a retainer device may be utilized to secure the platform at one or more desired angles of the second position.

Embodiments of the closure 100 may include a flexible member 134 coupled to the spine 110 and the platform 210. The flexible member 134 is configured to retain the platform 210 at the angle in the second position (e.g., depicted in FIG. 3). In a particular embodiment, the flexible member 134 is coupled to the spine 110 and the platform 210 at or proximate to the second end 105 and hinges from the hinge interface 120 at or proximate to the first end 104. In various embodiments, the flexible member 134 is configured to compress to allow movement of the platform 210 from the second position (e.g., FIG. 3) to the first position (e.g., FIG. 2). The flexible member 134 is further configured to extend to retain the platform 210 at the angle in the second position. In certain embodiments, the flexible member 134 is a strap, a band, or a cord, or a tensioner device. Referring to FIG. 3, the spine 110 may include a first bridge 136A at the second wall 116 at which a first end of the flexible member 134 is connected. The platform 210 may include a second bridge 136B at which a second end of the flexible member 134 is connected. The flexible member 134 may be adjustable through one or both bridges 136A, 136B, such as to allow for various angles or arcs of the platform 210 from the second wall 116.

Referring still to FIG. 3, various embodiments of the closure 100 include a platform retention member 130 positioned or formed at the second wall 116 of the spine 110. The platform retention member 130 is configured to releasably affix the platform 210 in the first position (e.g., depicted in FIG. 2). In particular embodiments, the platform 210 forms an opening 132 through which the platform retention member 130 is extendable and attachable to the platform 210. The platform retention member 130 may form a fitted interface, such as a snap fit, a press fit, an interference fit, or other appropriate fit. A user may pinch tabs, flaps, or other surfaces at the platform retention member 130 to release the platform 210 from the platform retention member 130, allowing for rotation of the platform 210 along the arc into the second position, or to detach the platform 210 from the closure 100.

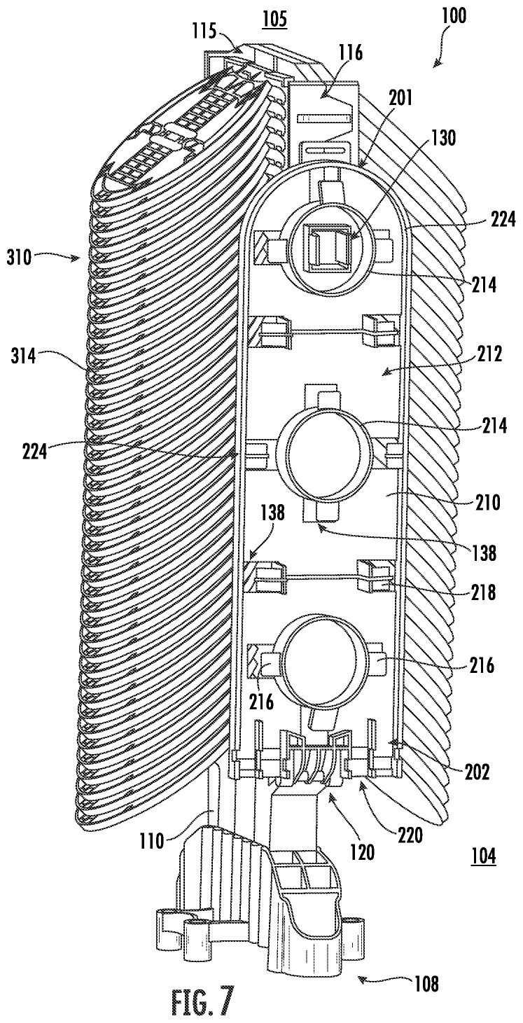

Referring now to FIGS. 2-8 generally, or particularly depicted in FIG. 7, particular embodiments of the platform 210 may include features allowing a user to store different lengths of loose leads to the platform 210. Such features may allow for compact organization of the leads while mitigating formation of undesired stresses or strain that may otherwise damage or deteriorate the leads. Such features may additionally, or alternatively, allow for sufficient slack, such as to allow for routing to one or more splices, maintenance, increased capacity, or thermal expansion and contraction, without damaging or deteriorating physical or material properties of the leads. Features at the platform 210 described herein are described relative to the platform 210 at the first position. Accordingly, one skilled in the art will appreciate that orientations provided herein may adjust accordingly relative to an orientation of the platform 210, such as e.g., the platform 210 extended in the second position, or removed from the closure 100.

Embodiments of the platform 210 may include a platform face 212 extending along the vertical axis 101 and along the lateral axis 102. The platform 210 may include a spool 214 extending from the platform face 212 The spool 214 may extend from the platform face 212 along the transverse axis 103. In certain embodiments, the spool 214 forms a substantially circular cross-section wall extending from the platform face 212. The spool 214 may particularly extend outward along the transverse axis 103 from the platform face 212. However, it should be appreciated that other cross-sectional geometries may be utilized, including, but not limited to, elliptical, ovular, or polygonal.

Referring still to FIGS. 2-8, in various embodiments, the spool 214 forms a spool tab 216. The spool tab 216 extends substantially along the vertical axis 101, the lateral axis 102, or an angle therebetween. The spool 214 may include one, two, three, or four or more spool tabs 216 configured to allow loose leads to secure around the spool 214 and fix in place at the spool 214. The spools 214 may have different geometries, such as different diameters, quantities of spool tab 216, or different geometries of spool tab 216, relative to one another, such as corresponding to desired sizes of tubing, cabling, fibers, or other materials the spool 214 may retain.

In still various embodiments, the platform 210 includes or a platform tab 218 extending from the platform face 212. In certain embodiments, the platform tab 218 is positioned along the vertical axis 101 between a pair of spools 214. The platform tab 218 may extend along the lateral axis 102, the vertical axis 101, or an angle therebetween, such as described in regard to any one or more configurations of the spool tab 216. The platform tab 218 is configured to retain tubing, cabling, or fibers, such as described in regard to the spool tab 216.

In particular embodiments, an opening 138 is formed at the platform 210 corresponding to a respective platform tab 218, spool tab 216, or both. The opening 138 is extended through the platform face 212, such as through the platform face 212 along the transverse axis 103. The opening 138 may be utilized to route leads through the platform face 212, such as to one or more tray plates 314 as further described herein.

In still certain embodiments, the platform 210 forms an open end 201 proximate to the first end 104 and a closed end 202 proximate to the second end 105. The platform 210 includes a perimeter wall 224 extending along the transverse axis 103 relative to the first position. The perimeter wall 224 extends along a peripheral edge of the platform face 212. An interior 226 of the platform 210 is formed at the platform face 212 and within the perimeter formed by the perimeter wall 224. The perimeter wall 224 forms the closed end 202 proximate to the second end 105. The perimeter wall 224 forms the open end 201 proximate to the first end 104.

Referring now particularly to FIG. 4, the platform 210 may form a retainer member 220 at or proximate to the closed end 202. The retainer member 220 forms a hook, clip, or finger extending along the transverse axis 103. In certain embodiments, the platform 210 forms an opening 222 extending through the platform face 212 along the transverse axis 103 and proximate to the retainer member 220. The retainer member 220 and the opening 222, separately or together, may provide surfaces at which leads may be secured. The retainer member 220 or opening 222 may allow for loose or excess leads to be routed from the first end 104 toward the second end 105 and fixed to the platform 210 while mitigating build-up of stresses or strain, such as stresses or strain that may be associated with rotating the platform 210 between the first and second positions. The retainer member 220, the opening 222, or both, may limit relative movement of the leads when rotating the platform 210 between the first and second positions.

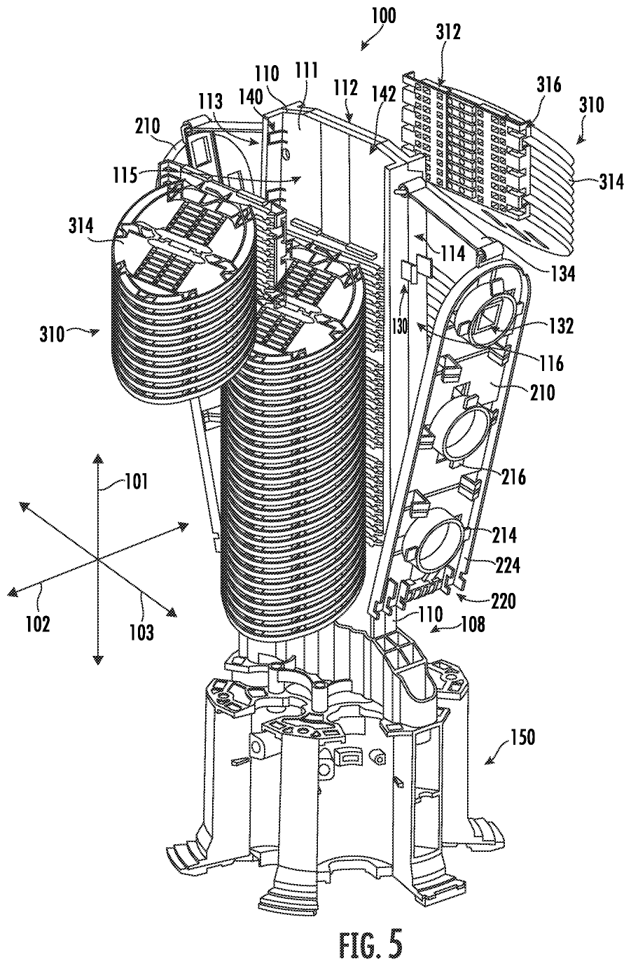

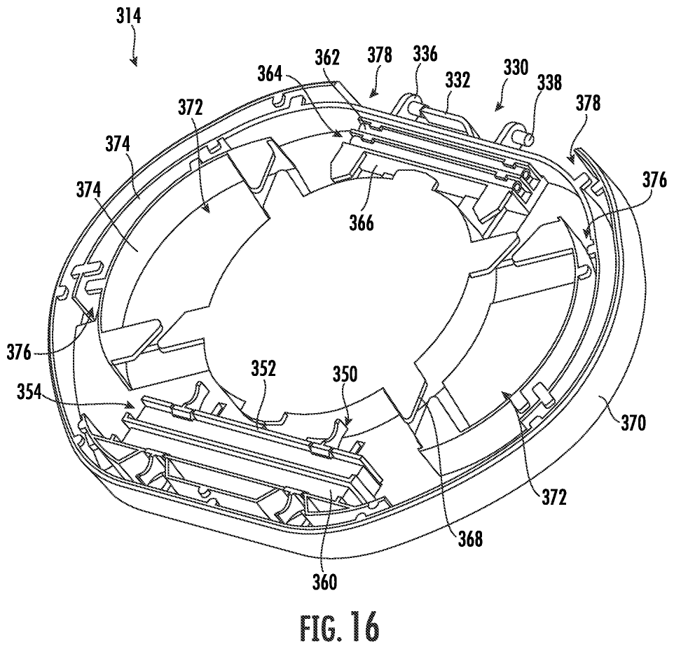

Referring back to FIGS. 2-15, and further depicted in whole or in part in various embodiments depicted at FIGS. 16-25, various embodiments of the closure 100 include a tray assembly 310 releasably attachable to the first wall 115 of the spine 110. Referring particularly to FIG. 5, various embodiments of the tray assembly 310 include a tray panel 312 extending along the vertical axis 101 and a plurality of tray plates 314 releasably attachable to the tray panel 312. The spine 110 may include a tray retention member 140 positioned in a track 142 formed by the spine 110. The tray retention member 140 is configured to releasably attach the tray assembly 310 to the spine 110. In certain embodiments, the tray retention member 140 may form a fitted interface, such as a snap fit, a press fit, an interference fit, or other appropriate fit, such as described in regard to the platform retention member 130. In still certain embodiments, the tray panel 312 forms a slot 316 receivable at the tray retention member 140. Tray panel 312 may further form a lead retainer member 318 forming a hook, finger, or other member configured to hold, support, secure, or organize a lead, such as described herein.

Referring still to FIG. 5, in a still particular embodiment, the tray retention member 140 is configured to receive the tray assembly 310 from along the lateral axis 102. Accordingly, pluralities of tray assemblies 310 may be positioned in adjacent arrangement along the vertical axis 101 while allowing detachment of one or more tray assemblies 310 without requiring detachment of an adjacent tray assembly 310, such as a tray assembly positioned above another along the vertical axis 101.

In still various embodiments, a plurality of tray panels 312 is stackable along the vertical axis 101 and each tray panel 312 may include a plurality of tray plates 314, such as splice trays or splitter trays. The tray panel 312 allows for different configurations of individual tray plates 314, such as depicted and described regarding FIGS. 16-25, to be included among the plurality of tray plates 314. The different configurations include features specific to various fiber counts, splices and splice devices, splitter devices, fiber types, fiber slack, etc.

In a particular embodiment, such as depicted at FIG. 5, the track 142 is formed along the first wall 115 and extending along the vertical axis 101. The track 142 is further formed in an area along the lateral axis 102 between the pair of second walls 116. A first track 142 is formed alongside the first face 111 and a second track 142 is formed alongside the second face 112. In a still particular embodiment, the closure 100 includes a first plurality of tray assemblies 310 in adjacent arrangement along the vertical axis 101 and a second plurality of tray assemblies 310 in adjacent arrangement along the vertical axis 101 and spaced apart along the lateral axis 102 from one another. In particular, the first plurality of tray assemblies 310 is positioned along the first face 111 and the second plurality of tray assemblies 310 is positioned along the second face 112. Each plurality of tray assemblies 310 is positioned at respective tracks 142 alongside the respective faces 111, 112. The plurality of tray assemblies 310 may include two or more stacks of tray plates 314 held together by a respective tray panel 312. The tray panel 312, including the plurality of tray plates 314, is stacked in vertical arrangement along the track 142. The tray assembly 310 may be positioned approximately 90 degrees relative to the platform 210. A pair of platforms 210 may be spaced apart from one another along the transverse axis 103 and a plurality of tray assemblies 310 may be positioned therebetween along the transverse axis 103.

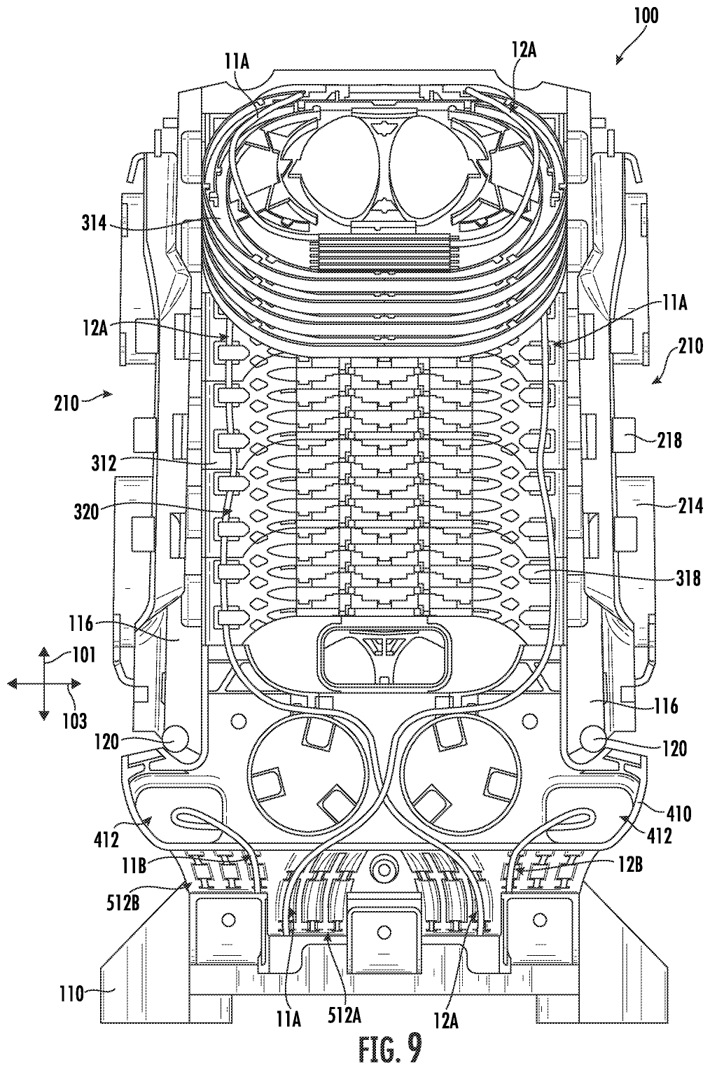

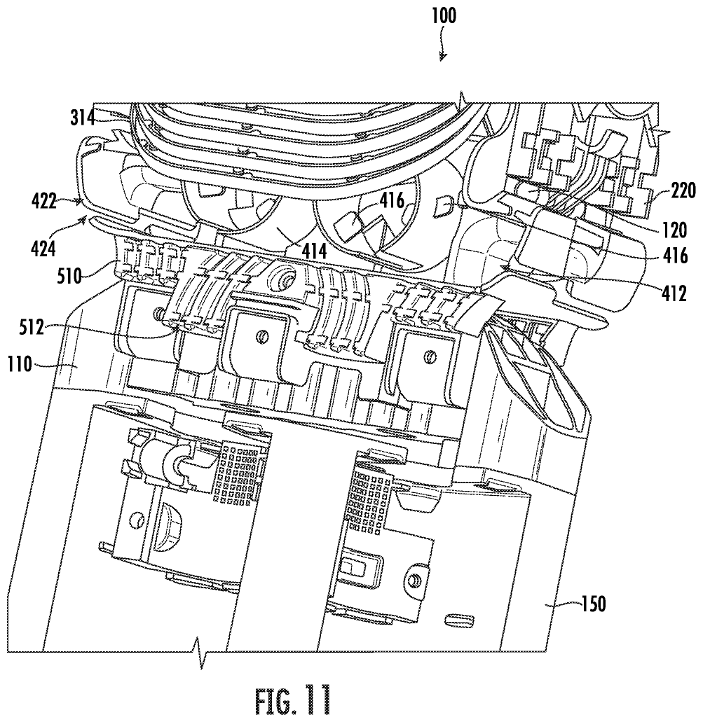

Referring now to FIGS. 9-14, in various embodiments, the closure 100 includes a routing panel 410 attachable to the spine 110. The routing panel 410 forms a passage 412 below the platform 210 along the vertical axis 101 when the routing panel 410 is attached to the spine 110. The passage 412 extends substantially along the lateral axis 102. In certain embodiments, the passage 412 is formed by walls 422 extending at least partially around a central axis co-directional to the lateral axis 102. Referring particularly to FIGS. 11-14, the walls 422 may be discontinuous, such as to form a slot 424 extending along the lateral axis 102 through the wall 422. The slot 424 may allow the leads to route along the vertical axis 101 through the slot 424 to and from the platform 210. In particular, the slot 424 formed through the wall 422 be secured at the retainer member 220 at the platform 210. The slot 424 may particularly be formed through the wall 422 proximate to the platform 210, such as proximate relative to the hinge interface 120, the retainer member 220, or both. The leads may accordingly route to the platform 210 while being secured in place and having stresses or strain mitigated or eliminated from forming from the rotation of the platform 210.

Referring now to FIGS. 9-12, in certain embodiments the routing panel 410 includes a routing panel spool 414 extending along the lateral axis 102. The routing panel spool 414 may be formed substantially similarly as any one or more embodiments of spool 214 described herein. In certain embodiments, the routing panel 410 includes a routing panel tab 416 extending from one or more of spool 414. Tab 416 may extend along the vertical axis 101, the traverse axis 103, or an angle therebetween. In certain embodiments, spool 414 forms a substantially circular wall extending along the lateral axis 102 from a transversely-extended face of the routing panel 410. Various embodiments of tab 416 are configured to retain leads such as described in regard to the tab 216, 218.

In still particular embodiments, the closure 100 includes a tube holder 510 attachable to the routing panel 410. The tube holder 510 forms a channel 512, or particularly a plurality of channels 512, extending substantially along the vertical axis 101. In certain embodiments, a first plurality of channels 512A extends substantially along the vertical axis 101 and turn along the lateral axis 102 toward the spool 414. A second plurality of channels 512B extends substantially along the vertical axis 101 and turn along the lateral axis 102 toward the passage 412, such as to direct leads toward the passage 412. The tube holder 510 may secure loose leads, or particularly tubes thereof, in place at the channel 512. The tube holder 510 may further secure loose leads without constraining each individual lead, or particularly a tube thereof.

Referring now to FIG. 9 and FIGS. 12-14, an exemplary embodiment of routing leads at an embodiment of the closure 100 is provided. It should be appreciated that the embodiments depicted illustrate an exemplary method for routing, and one skilled in the art will appreciate that other methods may be utilized, such as based on the quantity, type, and application of the leads. In FIG. 9, input lead 11, such as an input fiber, is routed along the vertical axis 101 from the base 150 through channel 512. A first input lead 11A may route through channel 512A along the vertical axis 101. Spool 414 and tab 416 help organize, secure, and direct the lead 11A along the vertical axis 101 to the desired tray assembly 310. Input lead 11A is secured and worked at the tray plate 314 in any appropriate manner, such as spliced at the tray plate 314. A first output lead 12A is egressed from the tray plate 314, such as substantially described with regard to the first input lead 11A routed to the tray plate 314.

A second input lead 11B may route through channel 512B and through passage 412, such as to route along the lateral axis 102 from a first side (e.g., corresponding to first face 111) of the closure 100 to a second side (e.g., corresponding to second face 112). The second input lead 11B may route to the tray plate 314 along the vertical axis 101 at the second side substantially similarly as described in regard to the first input lead 11A at the first side. A second output lead 12B may egress from the tray plate 314 from the second side and through passage 412 substantially similarly as described in regard to the first output lead 12A at the first side.

In an exemplary embodiment of a method for routing leads through the closure, leads 11A, 12A are routed vertically into tray assembly 310, they may be constrained within channel 320 formed by an arrangement of lead retainer member 318 in vertical arrangement along the vertical axis 101. The lead is routed along the vertical axis 101 to the desired tray plate 314 and routed along the lateral axis 102 across tray mounts adjacent to the respective wall 115 at a rear of the tray plate 314 at which the tray plate 314 is attached.

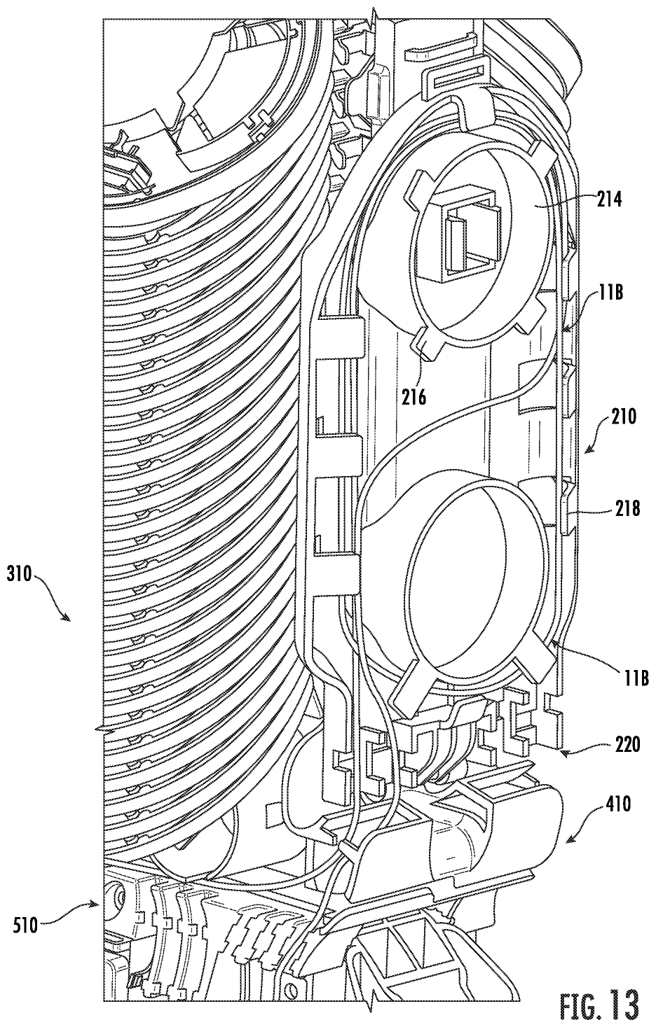

Referring to FIG. 13, in an exemplary embodiment of a method for routing leads through the closure, excess or loose lead from the second input lead 11B may be routed through the passage 412 and through slot 424 to platform 210. Spool 214, tabs 216, 218, retainer member 220, or openings 222, 138 may hold, support, or organize the lead 11B such as described herein. In FIG. 13, the lead 11B may route to the same side (e.g., first side) from which the lead 11B routed into the passage 412.

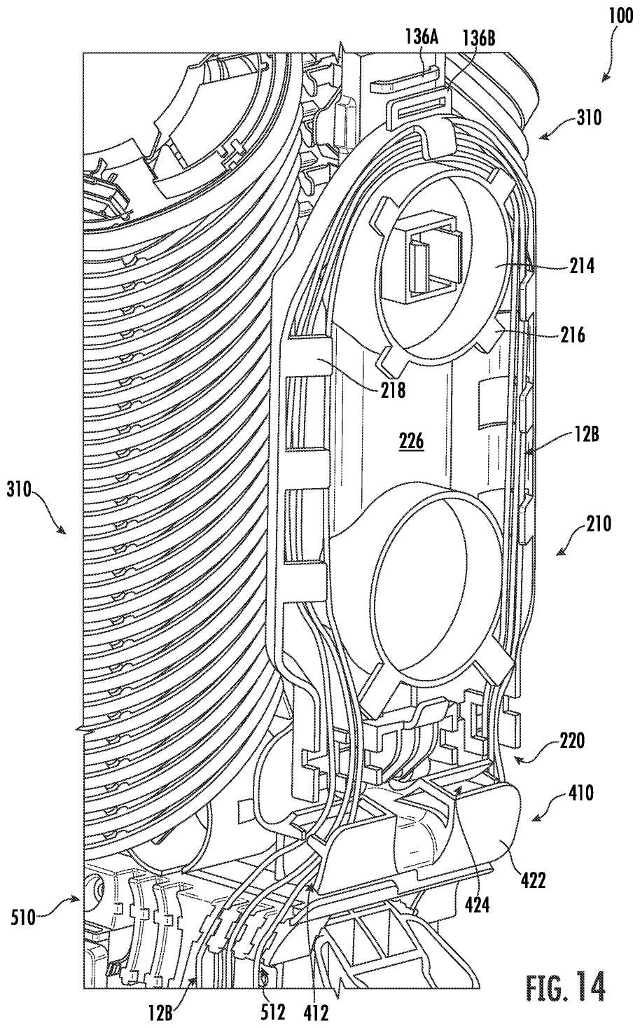

Referring to FIG. 14, in an exemplary embodiment of a method for routing leads through the closure, excess or loose lead from the second output lead 12B may be routed through the passage 412 and through slot 424 to platform 210, such as described in regard to FIG. 13. In FIG. 14, the lead 12B may route to the opposite side (e.g., second side) from which the lead 12B routed into the passage 412.

It should be appreciated that FIGS. 13-14 provide exemplary illustrations of lead routing. Accordingly, other methods, such as routing paths, loops, or destinations, may be utilized for any appropriate combination of input and output leads.

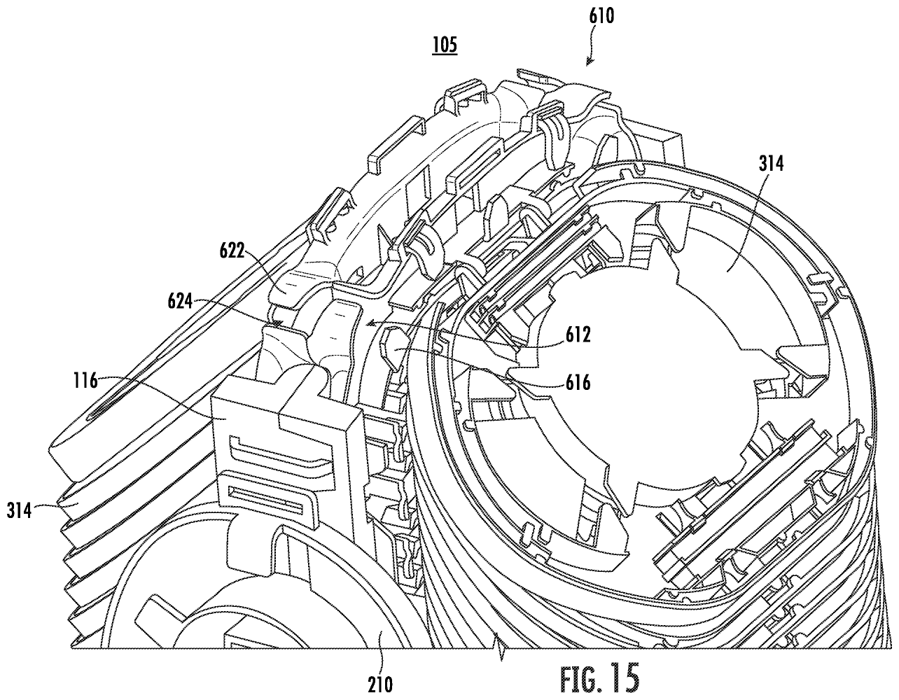

Referring now to FIG. 15, the closure 100 may include an upper routing guide 610 including a wall 622 forming a passageway 612 extending along the lateral axis 102. The upper routing guide 610 positioned at the second end 105 of the closure 100. In particular embodiments, the upper routing guide 610 is attachable to the spine 110 at the second end 105, such as distal along the vertical axis 101 from the base 150. In certain embodiments, the walls 622 are discontinuous, such as to form a slot 624 extending along the lateral axis 102 through the wall 622. The slot 624 may allow the leads to route along the vertical axis 101 through the slot 624. Various embodiments of the passageway 612 and the walls 622 may be formed substantially similarly as described regarding passage 412 and walls 422 at the routing panel 410.

Referring now to FIGS. 16-25, various embodiments of the tray plate 314 forming splice trays, splitter trays, or other appropriate modules fiber optic routing are provided. As described herein, each tray assembly 310 may include one or more embodiments of the tray plate 314, such as embodiments depicted and described regarding FIGS. 16-25, or other appropriate configurations. Embodiments of the closure 100 provided herein may include any desired quantity or combination of configurations of tray plates 314 to hold, support, and organize relatively large quantities of splice trays and splitter devices.

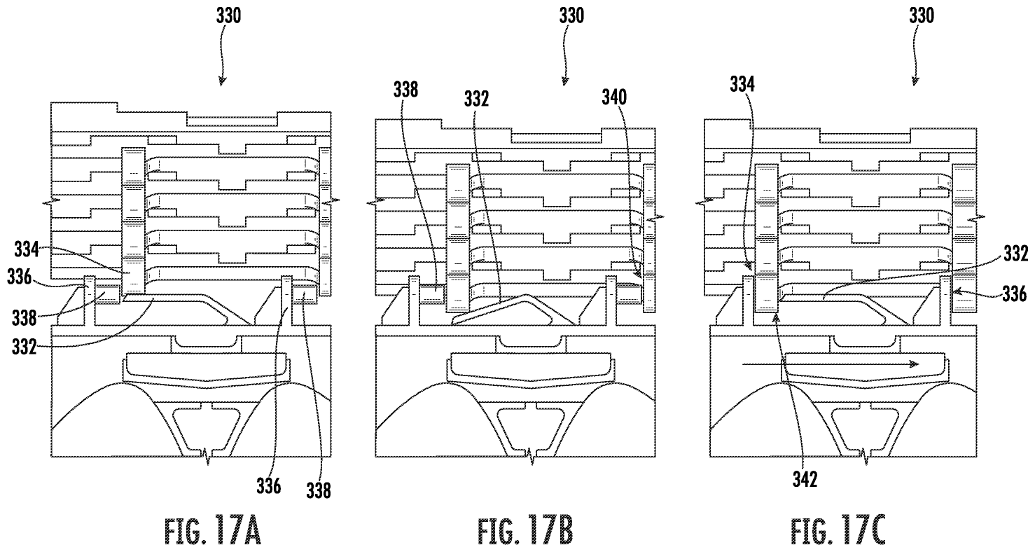

Referring now to FIGS. 16-21, exemplary embodiments of a tray plate 314 are provided. Referring particularly to FIGS. 17A-17C, an illustration of the tray plate 314 attaching to the tray panel 312 is provided. The tray plate 314 includes an attachment interface 330 at which the tray plate 314 is releasably attachable to the tray panel 312. The attachment interface 330 may form a snap-in panel at which an arm 332 is depressed and the tray plate 314 is slid (e.g., along lateral axis 102) into a receiver 334 at the wall 115. The attachment interface 330 may include a pair of posts 336 extended toward the tray panel 312. The post 336 includes a pin 338 extended along the lateral axis 102 and receivable at an opening 340 at the receiver 334. A groove 342 may be formed at the post 336 and configured to guide the arm 332 across the post 336 as the tray plate 314 is slid into the opening 340.

Referring now to FIG. 16, an exemplary embodiment of tray plate 314 is provided. Tray plate 314 may include flexible members 350, such as hooks or fingers, configured to retain splitters, fibers, or leads generally. The tray plate 314 includes walls 352 forming a channel 354 at which a splitter 360 is receivable in the channel 354. The flexible member 350 is positioned or formed at wall 352. Positive lean of the flexible member 350 into the channel 354 allows the member 350 to adapt or conform to various sizes or geometries of splitter 360. The flexible member 350 is constructed of a compliant material allowing for the splitter 360 to push the member 350 away from the channel 354 until splitter 360 is fully seated in the channel 354.

Various embodiments of the tray plate 314 include a perimeter wall 370 forming an interior 372 at which leads, splitter, splices, etc. are positionable. One or more interior walls 374 is extended within the interior 372 to form a conduit 376 through which leads are egressed to and from splices, splitters, or other appropriate structures. The perimeter wall 370 and the interior wall 374 may together form an opening 378 at a rear end of the tray plate 314, such as to allow leads to enter the interior 372 from a rear area proximate to the attachment interface 330 and tray panel 312. Walls 366 may form a channel 364 at which splice connectors, protectors, or other fiber optic structures 362 may be retained at the rear end proximate to the attachment interface 330. Tabs 368 may be formed to help hold, support, retain, or organize leads within the interior 372.

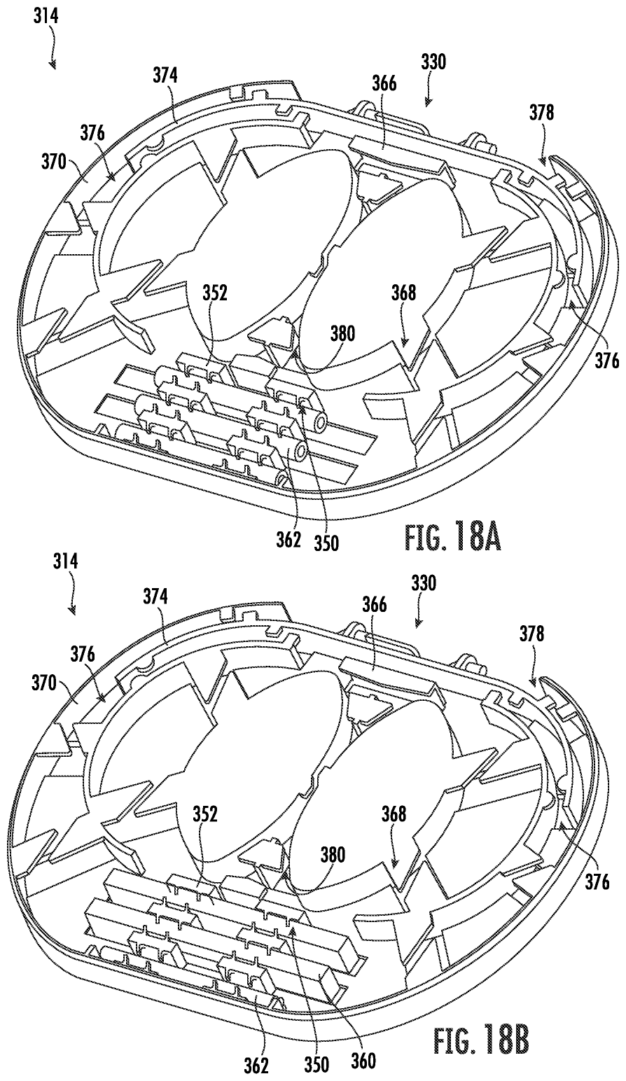

Referring now to FIGS. 18A-18B, the exemplary embodiment of the tray plate 314 is configured substantially as the embodiment depicted in FIG. 16. The embodiment in FIGS. 18A-18B may be configured as fiber optic ribbon trays. Walls 382 within the interior may form a central passage 380 through which leads may route. The flexible member 350 may be configured as an over-molded finger extending at an angle (e.g., an oblique angle) from wall 352. In a non-limiting exemplary embodiment, the tray plate 314 is configured to hold three fiber optic structures forming 12-fiber splices 362, such as depicted in FIG. 18A. In another non-limiting exemplary embodiment, the tray plate 314 is configured to hold two splitters 360 and an input splice protector 362.

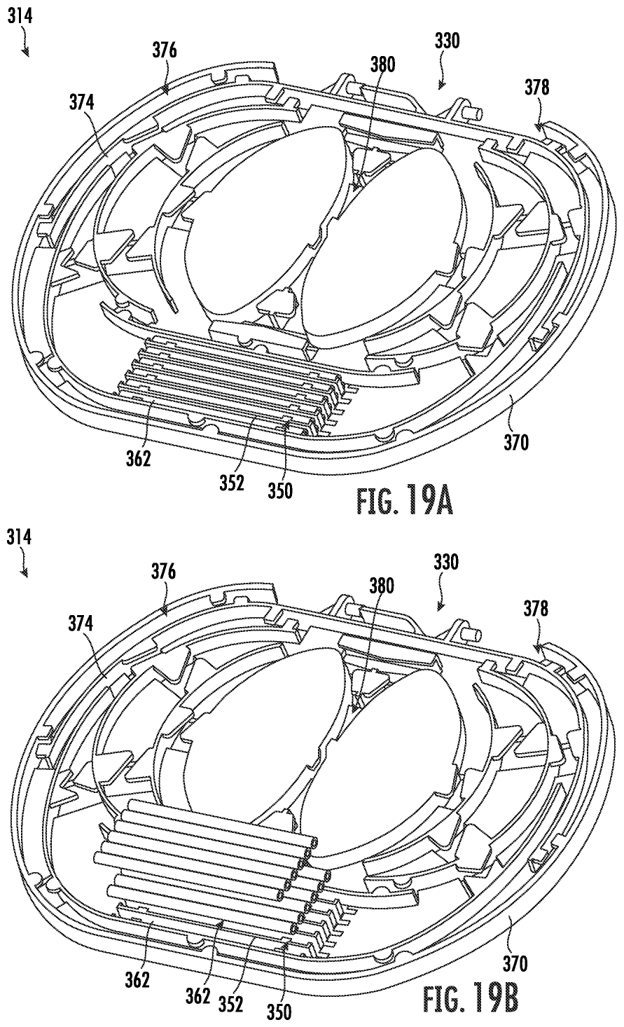

Referring now to FIGS. 19A-19B, the exemplary embodiment of the tray plate 314 is configured substantially as the embodiment depicted in FIGS. 18A-18B. The embodiment in FIGS. 19A-19B may be configured to hole a plurality of single fiber splices 362. The single fiber splices 362 may stack atop one another, such as depicted in the partially exploded view in FIG. 19B. In the non-limiting exemplary embodiment, the configuration holds twelve single-fiber splices 362, in which six pairs are stacked atop one another at respective channels 354.

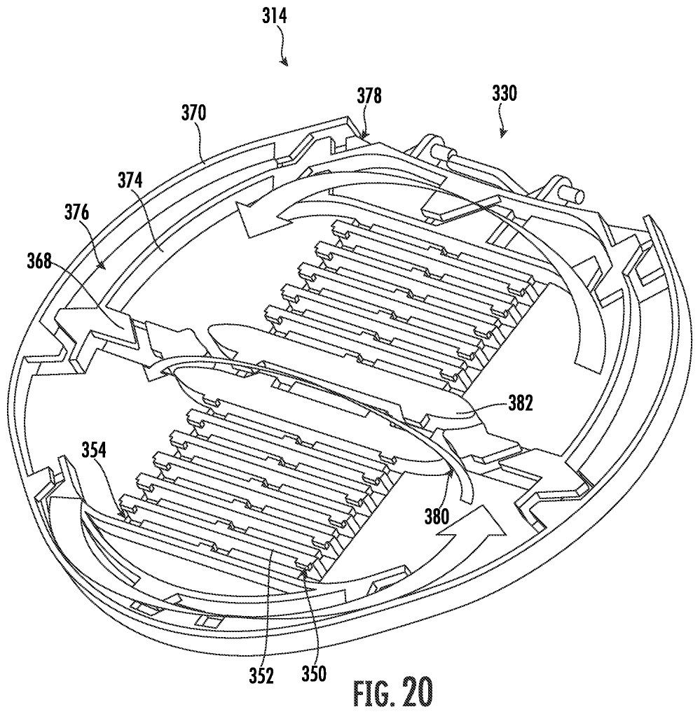

Referring now to FIG. 20, the exemplary embodiment of the tray plate 314 is configured substantially as the embodiment depicted in FIGS. 19A-19B. The embodiment in FIG. 20 depicts an exemplary routing path of leads at the tray plate 314. The tray plate 314 may be configured to hold twelve single-fiber splices through channels 354. Leads may be routed along an outer perimeter conduit 376 formed between the perimeter wall 370 and the interior wall 374. In certain embodiments, short lengths of lead may be routed through central passage 380.

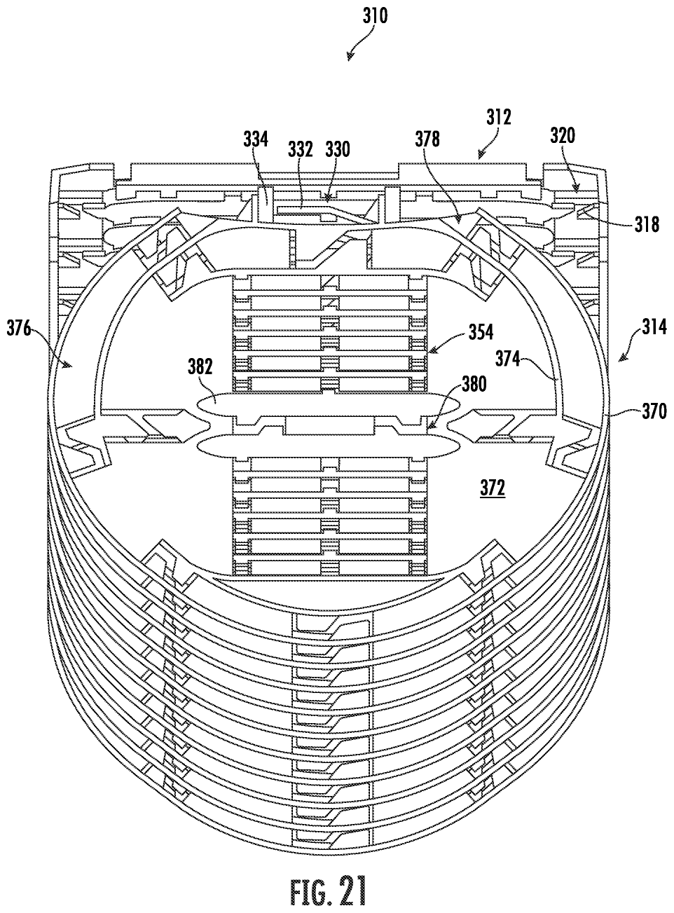

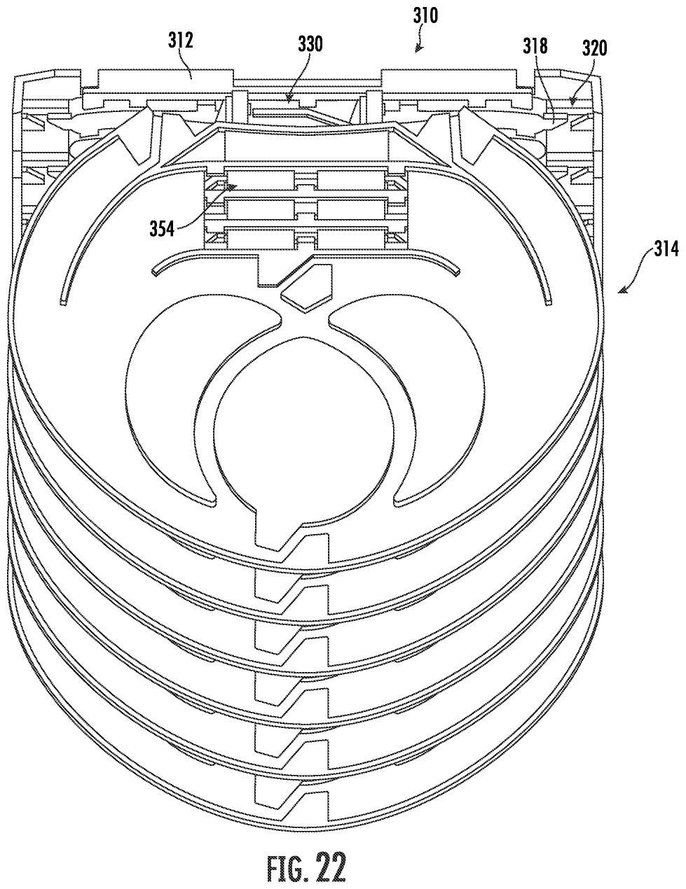

Referring now to FIGS. 21-22, exemplary embodiments of the tray assembly 310 including a plurality of tray plates 314 attached to the tray panel 312 is provided. Each tray plate 314 is connected to the tray panel 312 at attachment interface 330. Leads (not depicted) may route through channel 320 to enter into and egress from the tray plate 314 at opening 378. The embodiment depicted in FIG. 22 may include wider conduits 376, such as to accommodate ribbon fiber splicing. In a non-limiting exemplary embodiment, tray plate 314 may be configured to include three channels 354 for ribbon fiber splices.

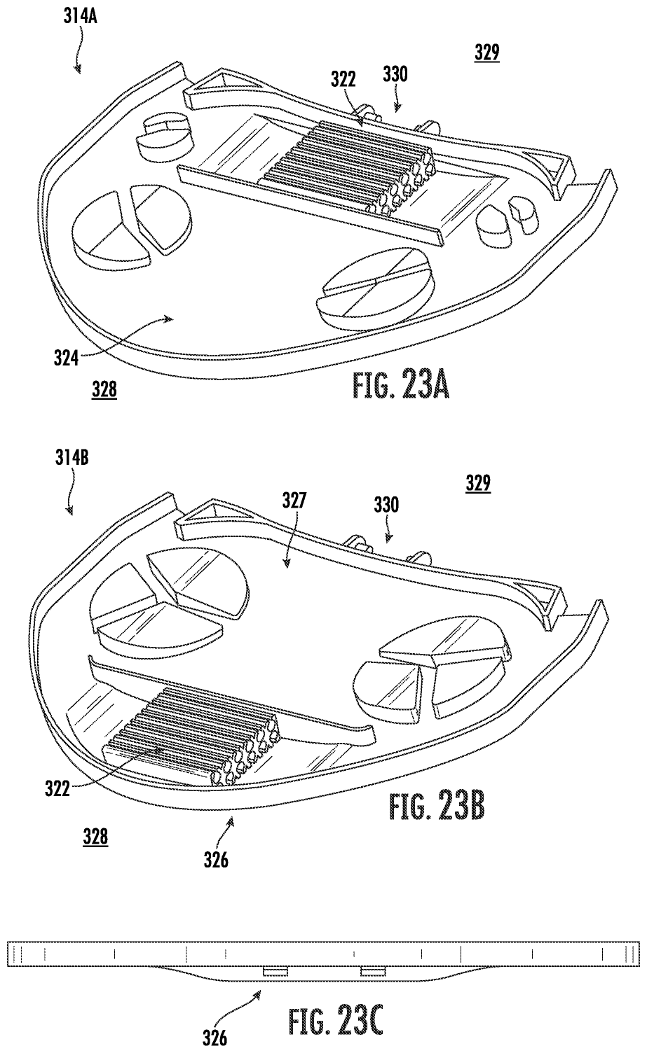

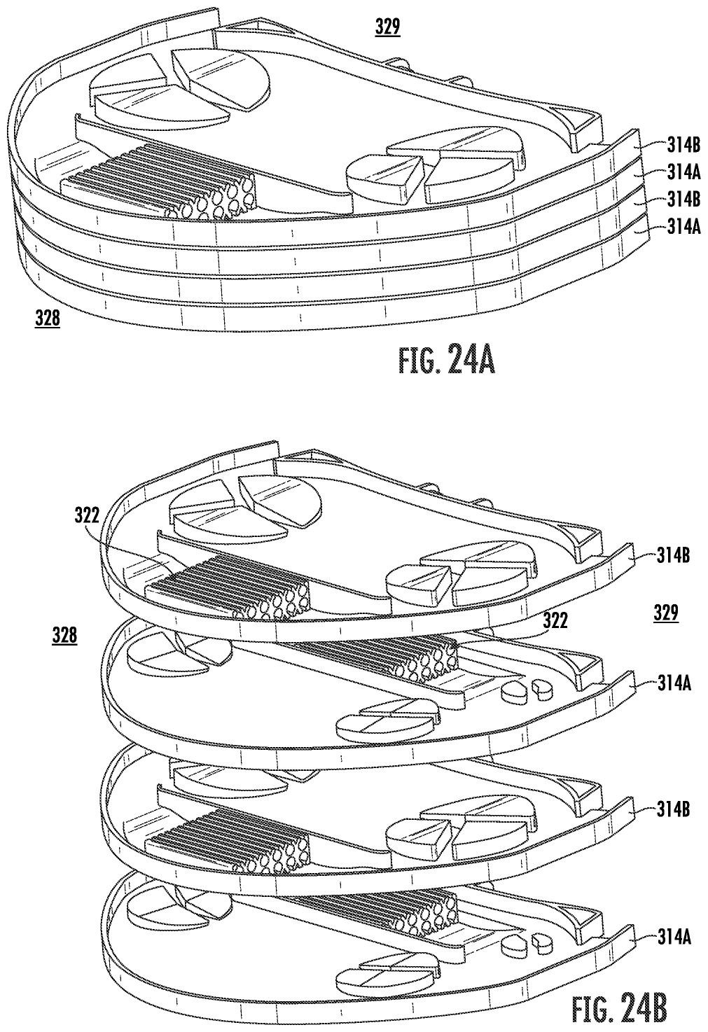

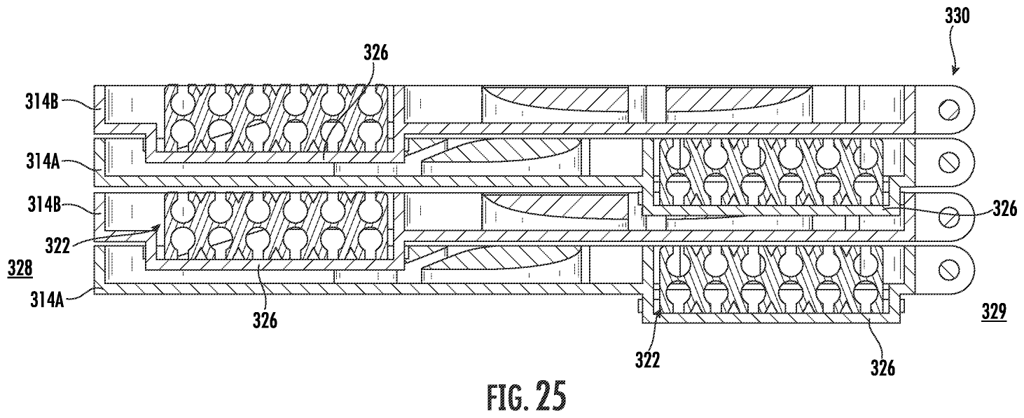

Referring now to FIGS. 23A-23C, FIGS. 24A-24B, and FIG. 25, an exemplary embodiment of a stackable tray plate 314 is provided. The tray plate 314 may be configured substantially as in regard to any one or more embodiments of tray plate 314 provided herein. FIG. 23A depicts a first tray plate 314A having a removable splice holder 322 positioned at a rear end 329 proximate to the attachment interface 330. In FIG. 23B, a corresponding second tray plate 314B includes the depression 326 at a front end 328 of distal to the attachment interface 330, such as depicted at side view FIG. 23C. The splice holder 322 is positioned at the depression 326. A corresponding interface 324 at the first tray plate 314A is configured to accept the second tray plate 314B and depression 326 atop the first tray plate 314A, such as depicted in the exploded view in FIG. 24B and the cross-sectional view in FIG. 25. Second tray plate 314B includes a raised surface 327 proximate to the rear end 329 corresponding to the rear end 329 at the first tray plate 314A at which the splice holder 322 is positioned. Accordingly, each tray plate 314A, 314B may rest flush on top one another when stacked, such as depicted in FIG. 24A. Trays 314A, 314B may index inside one another when installed in the closure 100. Such configuration may allow the tray plate 314 to be thick enough to support a removable fiber splice holder 322 where appropriate or necessary on the tray plate 314. The remainder of the tray plate 314 may be relatively thin such as to allow for a compact arrangement.

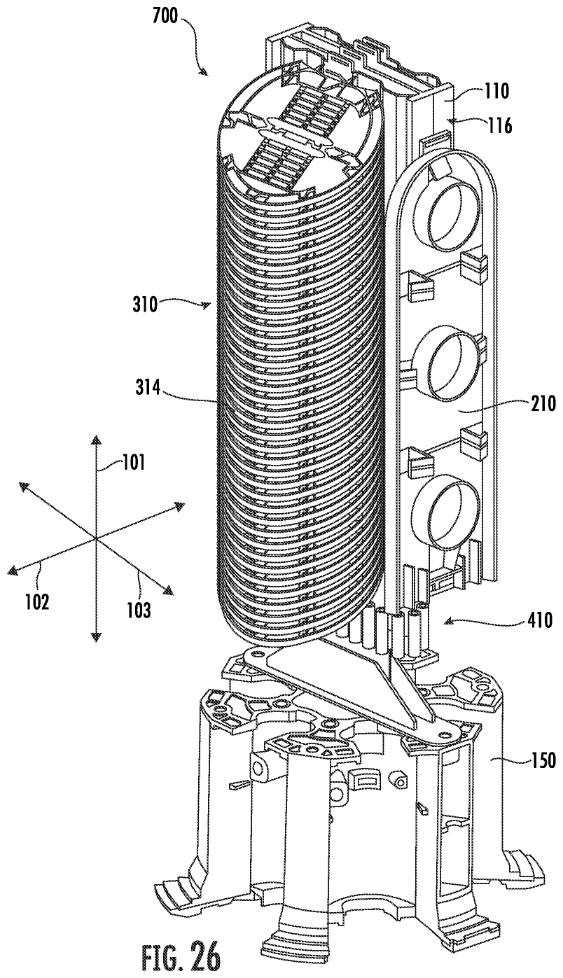

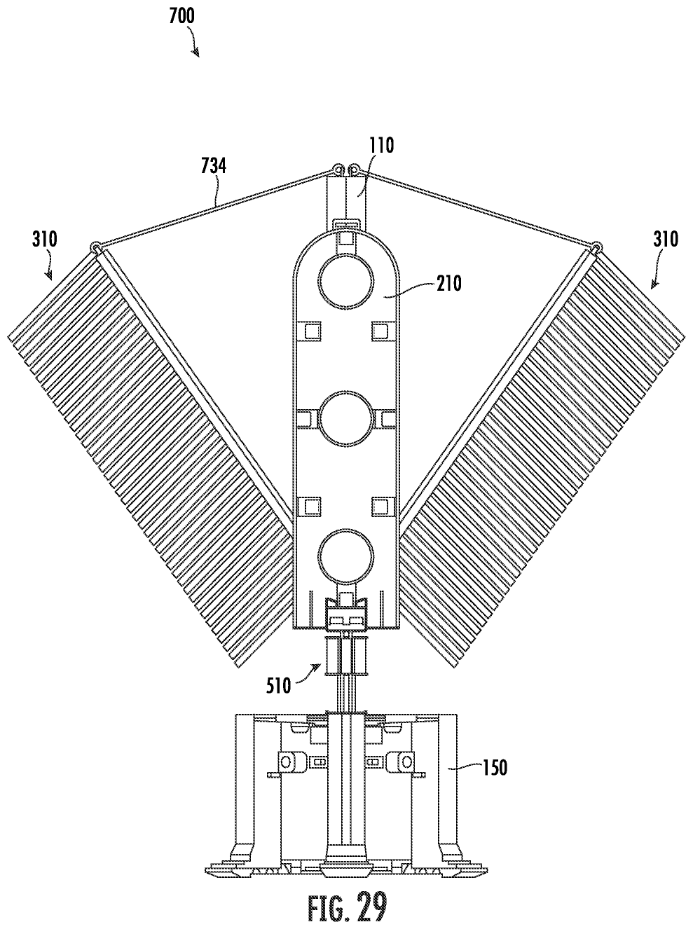

Referring now to FIGS. 26-28, perspective views of embodiments of a fiber optic closure 700 in accordance with aspects of the present disclosure is provided. Closure 700 includes a tray panel 712 extending along the vertical axis 101. Tray panel 712 is configured to hold a plurality of tray plates 314, including any one or more features depicted and described regarding tray panel 312. Tray panel 712 may extend as a substantially singular wall along the vertical axis 101. A pair of tray panels 712 is positioned at opposing sides of the spine 110. FIG. 29 depicts a side view of the closure 700 in an open position in which tray panels 712 of tray assembly 310 are in a second position between the vertical axis 101 and the lateral axis 102. The closure 700 provided herein may be encased in casing 22 such as depicted in FIG. 1, Closure 700 may further include tray assembly 310 such as described herein. Platform 210 is fixedly attached to the second wall 116. Flexible member 734 may be configured such as described regarding flexible member 134. However, flexible member 734 is attached to spine 110 from first wall 115. Flexible member 734 is furthermore attached to tray panel 712 of the tray assembly 310 to allow tray assembly 310 to rotate to an arc along the lateral axis 102.

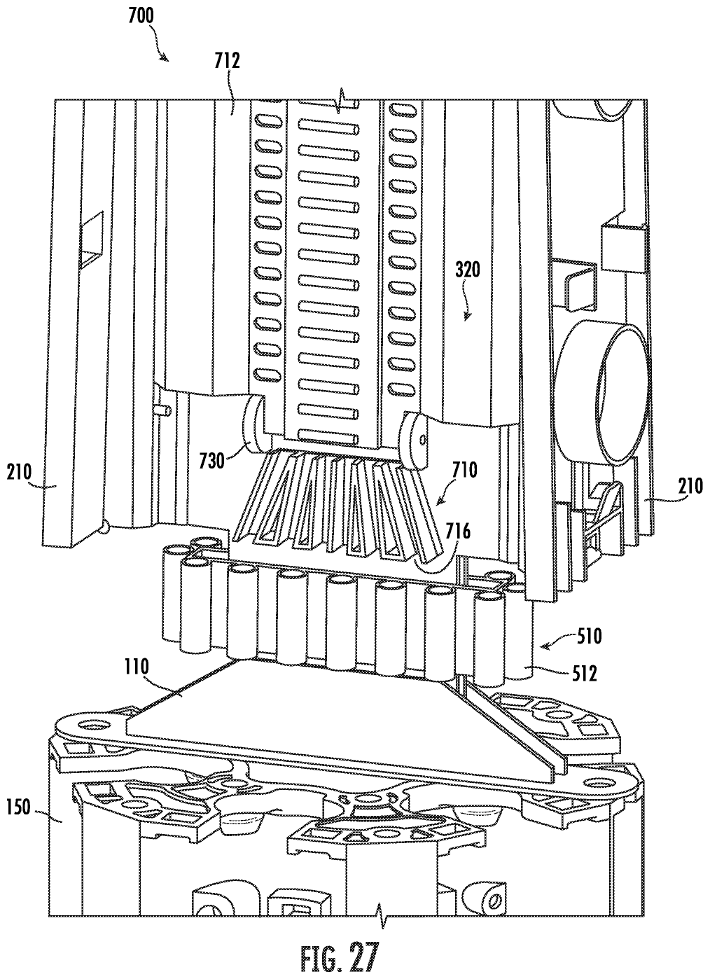

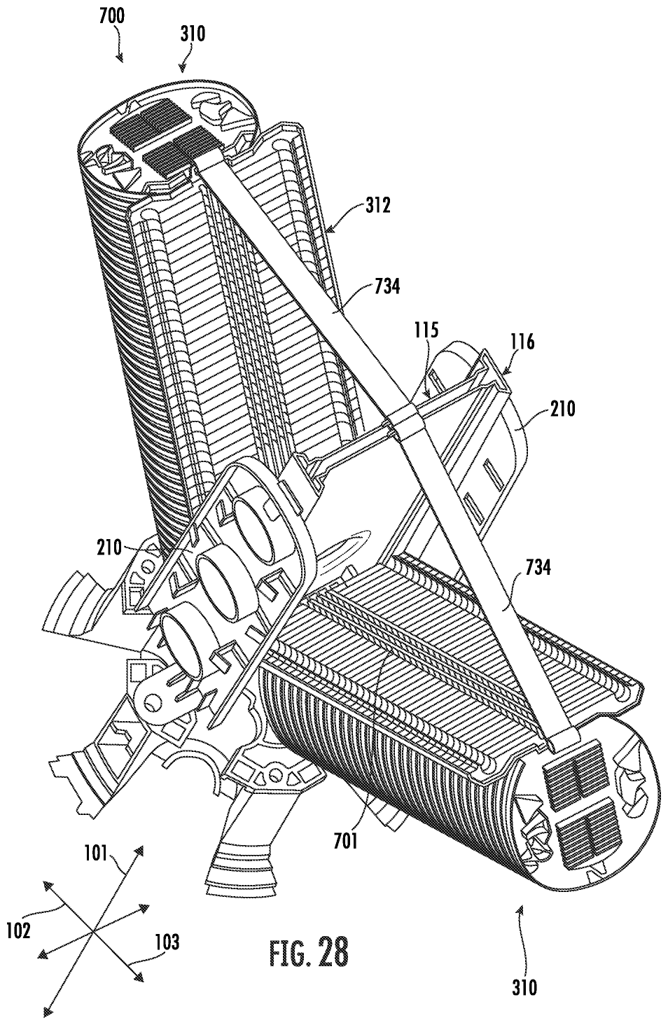

Referring to FIG. 27, closure 700 may include a routing panel 710 forming channels 716 extending along the vertical axis 101. Routing panel 710 is attachable to the spine 110 below a hinge assembly 730. The hinge assembly 730 is formed at an interface of the spine 110 to the tray panel 712. The hinge assembly 730 allows rotation of the tray panel 712 along an arc from a first position along the vertical axis 101 to a second position at an arc between the vertical axis 101 and the lateral axis 102. The channels 716 at the routing panel 710 are positioned between hinges of the hinge assembly 730, such as to feed or route leads 701 into a central or median portion of the tray panel 712, such as depicted in FIG. 28. Spine 110 is allowed to pivot along an arc to allow access to fiber routing tray panels 712 along a face that is adjacent to the first wall 115 when in the first position. Leads 701 are directed over the hinge assembly 730 at a bottom end of the spine 110 and through tray panel 712 into individual tray plates 314.

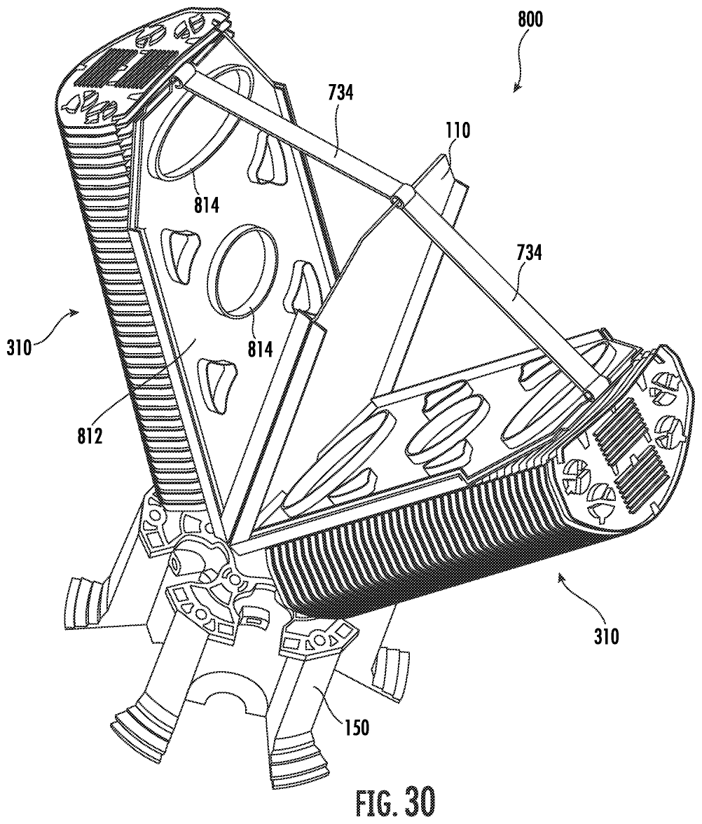

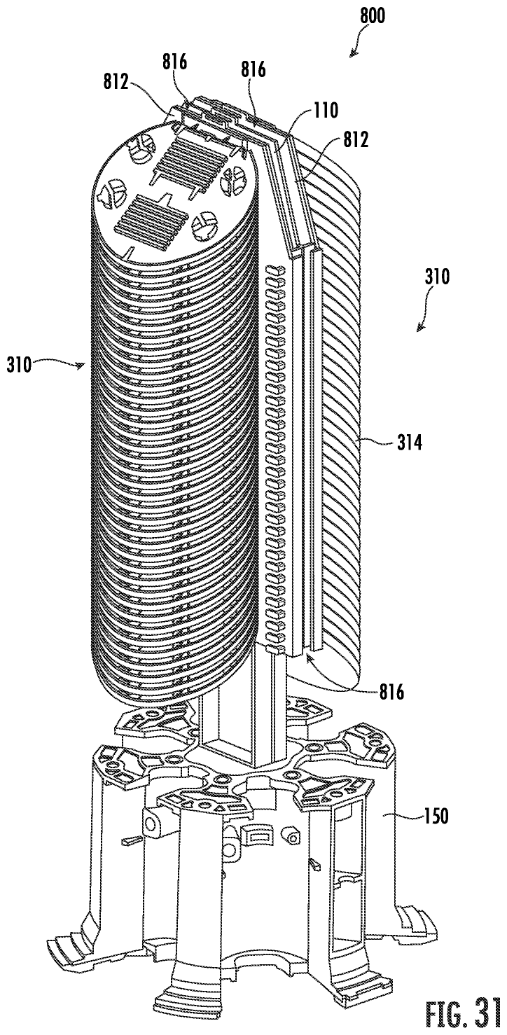

Referring now to FIGS. 30-31, perspective views of embodiments of a fiber optic closure 800 in accordance with aspects of the present disclosure is provided. Closure 800 depicted in FIGS. 30-31 may be configured similarly as depicted and described in regard to FIGS. 26-29. Closure 800 includes tray panel 812 configured to hold a plurality of tray plates 314 substantially similarly as described regarding tray panel 712. Panel 812 further includes spools 814 configured to hold, secure, or organize leads, such as described in regard to spool 214 herein. Between panel 812 and spine 110 a routing channel 816 extending along the vertical axis 101 along the distance of the panel 812. Closure 800 may omit platforms 210. Accordingly, leads may be kept inside of the closure 800 in the channel 816 between the spine 110 and the panel 812.

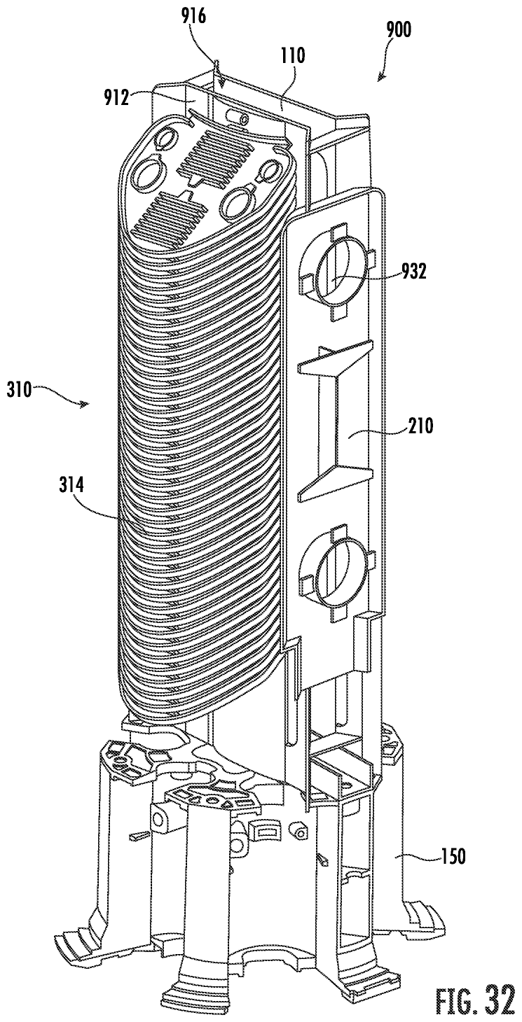

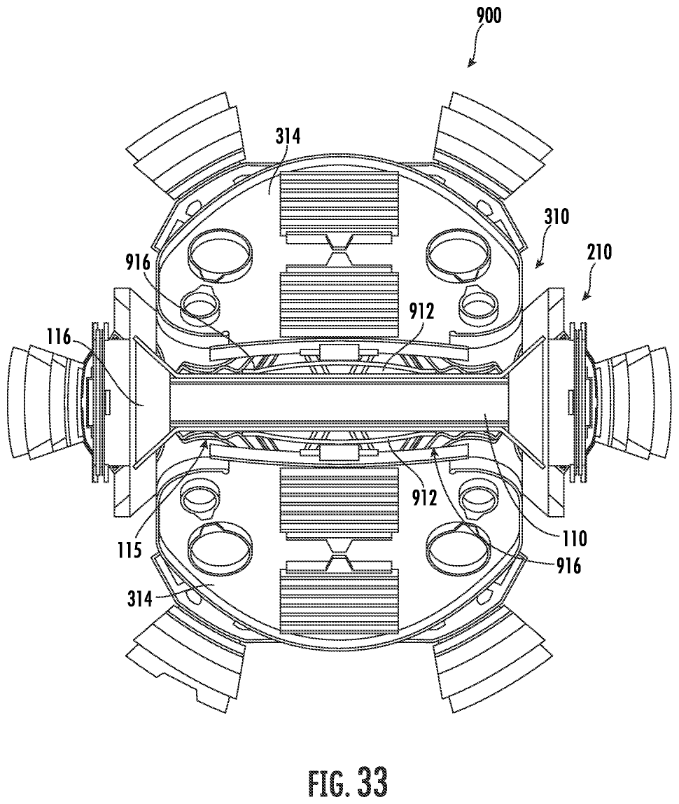

Referring now to FIG. 32, a perspective view of an embodiment of fiber optic closure 900 in accordance with aspects of the present disclosure is provided. FIG. 33 provides a top-down view of the embodiment depicted in FIG. 32. Closure 900 may be configured similarly as various embodiments of the closure provided herein. Platform 210 may include an opening 932 through which leads may route into an interior channel 916. Channel 916 is formed between spine 110 and panel 912, such as described regarding panel 812 and spine 110 in FIGS. 30-31.

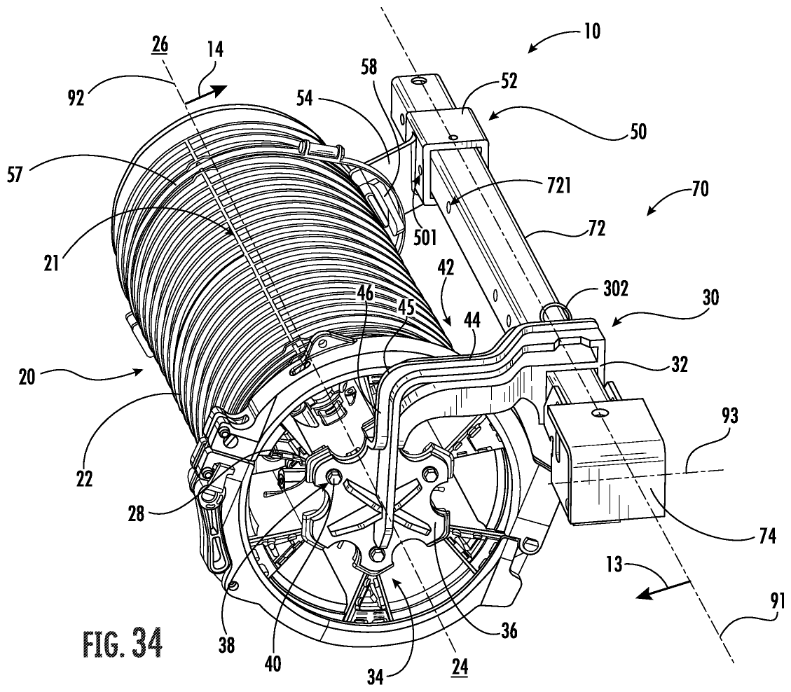

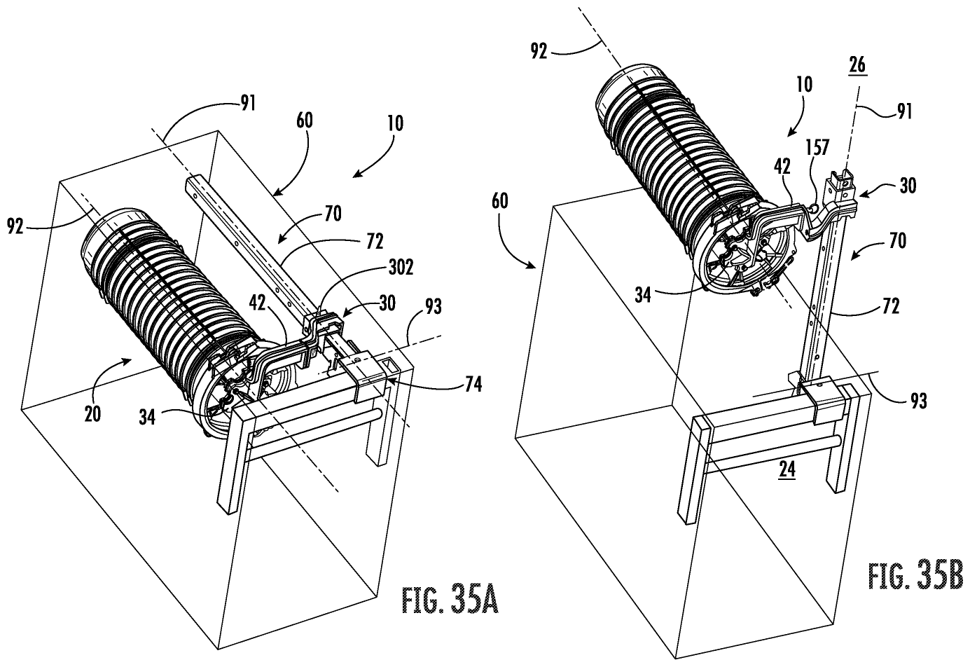

Referring now to FIGS. 34, 35A, and 35B, an embodiment of a mount structure 10 for any one or more embodiments of a closure 20 is provided. Closure 20 may include any one or more embodiments of closure 100, 700, 800, 900 depicted and described herein. A first axis 91 and a second axis 92 are extended substantially co-directional to one another. A first radial direction 13 is extended from the first axis 91 and a second radial direction 14 is extended from the second axis 92. A first end 24 and a second end 26 are defined and separated from one another relative to the first axis 91. In certain embodiments, the first end 24 is defined proximate to a third axis 93 extending perpendicular to the first axis 91, such as described further herein. The second end 26 is defined distal to the third axis 93. In certain embodiments, the first end 24 may refer to a bottom end of the fiber optic closure 20 and the second end 26 may refer to a top end of the fiber optic closure 20. The bottom end may particularly refer to an end or face of the fiber optic closure 20 through which one or more optical fibers or cables is extended into the casing 22, such as provided further herein. Accordingly, it should be appreciated that the optical fibers or cables may extend into the casing 22 through the top end, and orientations of the first end 24 and the second end 26 may be altered accordingly.

The casing 22 of the fiber optic closure 20 may form one or more ridges, ribs, or other raised walls 21 extended co-directional to the second axis 92 or circumferentially around the second axis 92 along an outer surface of the casing 22. The raised wall 21 may form a structural feature of the casing 22. Additionally, or alternatively, the raised wall 21 may form a locating feature, such as further described below.

The mount structure 10 includes a first bracket 30 extending along the first axis 91. The first bracket 30 includes a plurality of first bracket walls 32 at least partially surrounding the first axis 91. The mount structure 10 includes a rail assembly 70 having a rail 72 extending along the first axis 91. The rail 72 may include one or more rail walls extending along the first axis 91 and forming a bar, cross-bar, cantilevered member, rod, pipe, or other appropriate structure at which a first bracket 30 desirably attaches and detaches. In a particular embodiment, the rail 72 is configured as a telescoping rail extendable and retractable along the first axis 91.

The rail assembly 70 may include a pivot member 74 at which the rail 72 is coupled. The pivot member 74 is configured to rotate the first axis 91 along the third axis 93 extended perpendicular to the first axis 91. The third axis 93 may particularly extend through the pivot member 74 of the rail assembly 70. In a particular embodiment, such as provided further herein, the pivot member 74 may be configured to rotate the first axis 91 by up to approximately 90 degrees.

Various embodiments of the rail 72 include a rail opening 721 extended through one or more of the walls of the rail 72. In certain embodiments, such as depicted in FIG. 2, the first bracket 30 includes a first bracket opening 301 extended through one or more of the first bracket walls 32. The first bracket opening 301 corresponds to the rail opening 721 at the rail 72. The first bracket opening 301 allows a member, such as a key, bolt, pin, clamp, camlock, or other mechanical stop (hereinafter, “detent 302”) to extend through the first bracket opening 301 and the rail opening 721. When installed through the openings 721, 301, the detent 302 may prevent or otherwise disable movement, rotation, translation, or articulation of the first bracket 30 along the rail 72. When the fiber optic closure 20 is attached to the first bracket 30 such as described above, the fiber optic closure 20 is prevented from articulation along the first axis 91.

Referring to the embodiment depicted in FIG. 34, certain embodiments of the second bracket 50 include a second bracket opening 501 extended through one or more of a second bracket wall 52 at least partially surrounding the first axis 91. The plurality of second bracket walls 52 may be configured to form a pathway 51 through which the second bracket 50 may be positioned around the walls of the rail 72, such as described with regard to the first bracket 30. The detent 302 may be installed through the openings 721, 501 to prevent or otherwise disable movement, rotation, translation, or articulation of the second bracket 50 along the rail 72. When the fiber optic closure 20 is attached to the second bracket 50 such as described herein, the fiber optic closure 20 is prevented from articulation along the first axis 91. The second bracket 50, with the detent 302 extended through the openings 721, 501, may further disable articulation of the first bracket 30 and fiber optic closure 20.

A plate 34 including a plate wall 36 extending along the second radial direction 14 is extended from the second axis 92. A plate opening 38 extends along the second axis 92 through the plate wall 36. The plate opening 38 is configured to receive a fastener 40. The fastener 40 may include any appropriate type of mechanical fastener, such as, but not limited to, a bolt, screw, tie rod, and any appropriate nuts, sleeves, washers, bushings, collars, or other components as may be appropriate for fastening the fiber optic closure 20 to the plate 34 via the plate opening 38.

The mount structure 10 includes an arm 42 extending from the first bracket 30 to the plate 34. The arm 42 includes a first arm portion 44 extending along the first radial direction 13. The arm 42 includes a second arm portion 46 extending along the second radial direction 14. In a particular embodiment, the first arm portion 44 is extended from one or more of the plurality of first bracket walls 32. The second arm portion 46 is extended from the plate wall 36. In a still particular embodiment, the first arm portion 44 and the second arm portion 46 are extending toward one another and connected to form the arm 42.

In various embodiments, the first bracket 30 is attachable to, and detachable from, the rail 72. The first bracket 30 may be positioned along the first axis 91 proximate to first end 24. The first bracket 30 may support or hold the fiber optic closure 20 from the first end 24 or bottom end of the casing 22. In certain embodiments, the fiber optic closure 20 may suspended, or supported via the first bracket 30 cantilevering the closure 20 from the first end 24. In other embodiments, the mount structure 10 further includes a second bracket 50 attachable to, and detachable from, the rail 72 and separated from the first bracket 30 along the first axis 91. The second bracket 50 may particularly be separated along the first axis 91 from the first bracket 30 and proximate to the second end 26. A mechanical fastener or mechanical compression device, such as a clamp 57, is attached to the casing 22 and the second bracket 50, such as further described below.

During an embodiment of assembly, maintenance, installation, or other operation of the mount structure 10, the first bracket 30 is slid around the rail 72 from the second end 26 toward the first end 24. The fiber optic closure 20 is mounted or attached onto the plate 34 via one or more fasteners 40 extending through the plate opening 38 and into a corresponding interface at the fiber optic closure 20.

Referring now to FIGS. 35A-35B, perspective views of operation of embodiments of the mount structure 10 for the fiber optic closure 20 are provided. FIG. 35A depicts the fiber optic closure 20 within the enclosed volume 60. Embodiments of the mount structure 10 provided herein allow for the fiber optic closure 20 to be positioned substantially parallel to the first axis 91 and rail 72 within the enclosed volume 60. Operation of the mount structure 10 may include rotating the rail 72 via the pivot member 74 to position the rail 72 and first axis 91 substantially perpendicular or oblique relative to the second axis 92, such as depicted in FIG. 35B. Rotating the rail 72 may position the fiber optic closure 20 such as depicted in FIG. 3A. Operation of the mount structure 10 may further include removing the detent 302 from the first bracket 30 and the rail 72 to slide the fiber optic closure 20 and first bracket 30 toward the second end 26. Operation of the mount structure 10 may further include fixing the first bracket 30 to the rail 72, such as via the detent 302, after sliding the fiber optic closure 20 toward the second end 26. Operation of the mount structure 10 may include rotating the fiber optic closure 20 via removing the detent 157 from the arm 42 and rotating the arm 42. Rotating the arm 42 may position the fiber optic closure 20 substantially perpendicular or oblique to the first axis 91, such as depicted in FIG. 17B. Rotating the arm 42 may further allow the fiber optic closure 20 to be positioned out of the enclosed volume 60 while being positioned substantially perpendicular or oblique to the first axis 91. The fiber optic closure 20 may accordingly be positioned substantially horizontal or parallel to the ground. Such a position may facilitate access to the rear end (e.g., the fiber optic cables extending into the casing 22).

Embodiments of the mount structure 10 provided herein allow for movement, translation, articulation, or rotation of the rail assembly 70, such as rotation from a horizontal position (e.g., approximately zero degrees or parallel to the ground) to a vertical position (e.g., approximately 90 degrees or perpendicular to the ground). Additionally, or alternatively, the separable arm 42 from the first bracket 30 may allow the mount structure 10 to be articulated to the vertical position. The mount structure 10 may further include a removable pin, bolt, camlock, clamp, mechanical stop, or other detent 302 extendable through the rail 72 and the first bracket 30. Removing the detent 302 allows for the first bracket 30, separately from or together with the fiber optic closure 20, to be translated along the rail 72 to position the fiber optic closure 20 at a desired height. The detent 302 may be re-insertable at various portions of the rail 72 to fix the fiber optic closure 20 at the desired height, allowing for an operator to perform maintenance, assembly, disassembly, splicing, or other operations at the fiber optic closure 20 from a desired height, such as may be more ergonomic for the operator. Additionally, or alternatively, the detent 302 and translation of the first bracket 30 may allow for the fiber optic closure 20 to be stored within a relatively smaller enclosed volume 60 and/or on a shorter rail assembly 70 while allowing the fiber optic closure 20 to be re-positioned or translated to a desired operating height.

Embodiments of the mount structure 10 depicted and described herein may allow for relatively larger fiber optic closures 20 to be mounted into smaller enclosed volumes 60, which may allow for reduced volume of the enclosed volume. The mount structure 10 may form a fully external attachment relative to the fiber optic closure 20. As such, embodiments of the mount structure 10 provided herein may provide for fiber optic closure 20 mounting without generating or increasing risks associated with compromising, degrading, or damaging fluid seals at the fiber optic closure 20. For instance, embodiments of the mount structure 10 provided herein provide for mounting of the fiber optic closure 20 via existing threads, sleeves, or fasteners at the fiber optic closure 20. Embodiments of the mount structure 10 may furthermore provide for mounting and positioning without utilizing structures or components within the fiber optic closure 20 or egresses common to, intended for, or otherwise utilizable by one or more fiber optic cables 23. Still further, embodiments of the mount structure 10 may provide mounting while dissociating with splice capacity at the fiber optic closure 20, such as by avoiding utilization of ports, openings, or holes associated with one or more fiber optic cables.

Further aspects of the invention are provided by one or more of the following embodiments:
1. A fiber optic closure, wherein a reference coordinate system defines a mutually orthogonal vertical axis, lateral axis, and transverse axis, the closure including a spine extending along the vertical axis, the spine forming a first wall extending along the transverse axis, the spine forming a second wall extending along the lateral axis; a platform, the platform releasably attachable to the spine at the second wall, the platform configured to extend in a first position alongside the second wall along the vertical axis, the platform configured to extend in a second position at an angle from second wall between the vertical axis and the transverse axis; and a tray assembly releasably attachable to the first wall of the spine.
2. The fiber optic closure of any one or more clauses herein, the closure including a hinge interface rotatably coupling the platform to the spine at the second wall.
3. The fiber optic closure of any one or more clauses herein, the closure including a platform retention member positioned at the second wall of the spine, the platform retention member configured to fix the platform in the first position.
4. The fiber optic closure of any one or more clauses herein, the closure including a flexible member coupled to the spine and the platform, the flexible member configured to retain the platform at the angle in the second position.
5. The fiber optic closure of any one or more clauses herein, the platform including a platform face extending along the vertical axis and along the lateral axis when the platform is in the first position, the platform including a spool extending from the platform face.
6. The fiber optic closure of any one or more clauses herein, the spool including a spool tab.
7. The fiber optic closure of any one or more clauses herein, the platform including a platform tab extending from the platform face.
8. The fiber optic closure of any one or more clauses herein, the platform forming an open end proximate to the first end and a closed end proximate to the second end, the platform forming a retainer member at the closed end.
9. The fiber optic closure of any one or more clauses herein, the platform forming an opening through the platform face proximate to the retainer member.
10. The fiber optic closure of any one or more clauses herein, the spine including a tray retention member positioned in a track formed by the spine, the tray retention member configured to releasably attach the tray assembly to the spine.
11. The fiber optic closure of any one or more clauses herein( ), the tray assembly including a tray panel, wherein the tray panel is extending along the vertical axis when attached to the spine; and a plurality of tray plates releasably attachable to the tray panel.
12. The fiber optic closure of any one or more clauses herein, the tray panel forming a slot, the slot receivable at the tray retention member at the spine.
13. The fiber optic closure of any one or more clauses herein, the closure including a routing panel attachable to the spine, the routing panel forming a passage below the platform along the vertical axis, the passage extending along the lateral axis.
14. The fiber optic closure of any one or more clauses herein, the routing panel including a routing panel spool extending along the lateral axis.
15. The fiber optic closure of any one or more clauses herein, the closure including a tube holder attachable to the routing panel, the tube holder forming a channel extending along the vertical axis.
16. The fiber optic closure of any one or more clauses herein, the closure including an upper routing guide including a wall forming a passageway extending along the lateral axis, the upper routing guide positioned at the second end of the closure.
17. A fiber optic closure, wherein a reference coordinate system defines a mutually orthogonal vertical axis, lateral axis, and transverse axis, the closure including a spine extending along the vertical axis, the spine forming a first wall extending along the transverse axis, the first wall including a first face and a second face each extending along the transverse axis and the vertical axis, the first face and the second face each positioned opposite of one another along the lateral axis, the spine forming a second wall extending along the lateral axis, the second wall including a third face and a fourth face each extending along the lateral axis and the vertical axis, the third face and the fourth face each positioned opposite of one another along the transverse axis; a platform, the platform releasably attachable to the spine at each of the third face and the fourth face, the platform configured to extend in a first position alongside the second wall along the vertical axis, the platform configured to extend in a second position at an angle from second wall between the vertical axis and the transverse axis; and a plurality of tray assemblies releasably attachable to the first face and the second face of the spine, the plurality of tray assemblies attachable to the spine in adjacent arrangement along the vertical axis at the first face and the second face, each tray assembly including a tray panel extending along the vertical axis when attached to the spine, wherein a plurality of tray plates is releasably attachable to the tray panel.
18. The fiber optic closure of any one or more clauses herein, the closure including a hinge interface rotatably coupling the platform to the spine at the second wall.
19. The fiber optic closure of any one or more clauses herein, the spine including a tray retention member positioned in a track formed by the spine, the tray retention member configured to releasably attach the tray assembly to the spine.
20. The fiber optic closure of any one or more clauses herein, the closure including a flexible member coupled to the platform and the second wall at the spine and the platform, the flexible member configured to retain the platform at the angle in the second position.
21. The fiber optic closure of any one or more clauses herein, wherein the tray assembly includes a plurality of tray plates releasably attachable to a tray panel, wherein the plurality of tray plates is configured to rest flush on top of one another when stacked.
22. The fiber optic closure of any one or more clauses herein, wherein the plurality of tray plates each include a depression and a corresponding raised surface, wherein the depression at one tray plate is positioned to correspond with the raised surface at an adjacent tray plate.
23. The fiber optic closure of any one or more clauses herein, wherein the plurality of tray plates includes a second tray plate positionable flush on top of a first tray plate, wherein the first tray plate forms a depression at which a splice holder is removably positioned, and wherein the second tray plate forms a raised surface corresponding to the depression formed at the first tray plate.
24. The fiber optic closure of any one or more clauses herein, wherein the raised surface at the second tray plate is positioned at a rear end proximate to an attachment interface of the tray panel to the tray plate, and wherein the depression at the first tray plate is positioned at the rear end corresponding to the raised surface at the second tray plate.
25. The fiber optic closure of any one or more clauses herein, wherein the depression at the second tray plate is positioned at a front end distal to a rear end, and wherein the raised surface at the first tray plate is positioned at the front end corresponding to the raised surface at the second tray plate.
26. The fiber optic closure of any one or more clauses herein, wherein the tray panel is a singular wall extending corresponding to the vertical axis when installed to the spine.
27. The fiber optic closure of any one or more clauses herein, wherein the tray assembly includes an attachment interface at which the tray plate is releasably attachable to the tray panel.
28. The fiber optic closure of any one or more clauses herein, wherein the attachment interface forms a snap-in panel at which an arm is configured to depress into a receiver at the spine.
29. The fiber optic closure of any one or more clauses herein, wherein the attachment interface includes a pair of posts extending toward the tray panel, the post including a pin receivable at an opening at the receiver.
30. The fiber optic closure of any one or more clauses herein, wherein a groove is formed at the post and configured to guide the arm across the post as the tray plate is slide into the opening at the receiver.
31. A fiber optic closure, wherein a reference coordinate system defines a mutually orthogonal vertical axis, lateral axis, and transverse axis, the closure including a spine extending along the vertical axis, the spine forming a first wall extending along the transverse axis, the spine forming a second wall extending along the lateral axis a platform attached to the second wall of the spine and extending along the vertical axis; a tray panel releasably attachable to the first wall of the spine; a hinge assembly formed at an interface of the spine to the tray panel, wherein the hinge interface rotatably couples the tray panel to the spine at the first wall.
32. The fiber optic closure of any one or more clauses herein, the closure including a flexible member coupled to the spine and the tray panel, the flexible member configured to retain the tray panel at an angle in a second position.
33. The fiber optic closure of any one or more clauses herein, the closure including a routing panel attachable to the spine, the routing panel forming a passage below the tray panel along the vertical axis, the passage extending along the lateral axis.
34. The fiber optic closure of any one or more clauses herein, the closure including a tube holder attachable to the routing panel, the tube holder forming a channel extending along the vertical axis.
35. The fiber optic closure of any one or more clauses herein, wherein the routing panel forms a channel extending along the vertical axis.
36. The fiber optic closure of any one or more clauses herein, wherein the routing panel is attachable to the spine below the hinge assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A fiber optic closure, wherein a reference coordinate system defines a mutually orthogonal vertical axis, lateral axis, and transverse axis, the closure comprising:
a spine extending along the vertical axis, the spine forming a first wall extending along the transverse axis, the spine forming a second wall extending along the lateral axis;
a platform, the platform releasably attachable to the spine at the second wall, the platform configured to extend in a first position alongside the second wall along the vertical axis, the platform configured to extend in a second position at an angle from second wall between the vertical axis and the transverse axis; and
a tray assembly releasably attachable to the first wall of the spine.

2. The fiber optic closure of claim 1, the closure comprising:
a hinge interface rotatably coupling the platform to the spine at the second wall.

3. The fiber optic closure of claim 1, the closure comprising:
a platform retention member positioned at the second wall of the spine, the platform retention member configured to fix the platform in the first position.

4. The fiber optic closure of claim 1, the closure comprising:
a flexible member coupled to the spine and the platform, the flexible member configured to retain the platform at the angle in the second position.

5. The fiber optic closure of claim 1, the platform comprising a platform face extending along the vertical axis and along the lateral axis when the platform is in the first position, the platform comprising a spool extending from the platform face.

6. The fiber optic closure of claim 5, the spool comprising a spool tab.

7. The fiber optic closure of claim 5, the platform comprising a platform tab extending from the platform face.

8. The fiber optic closure of claim 1, the platform forming an open end proximate to a first end and a closed end proximate to a second end, the platform forming a retainer member at the closed end.

9. The fiber optic closure of claim 8, the platform forming an opening through a platform face proximate to the retainer member.

10. The fiber optic closure of claim 1, the spine comprising a tray retention member positioned in a track formed by the spine, the tray retention member configured to releasably attach the tray assembly to the spine.

11. The fiber optic closure of claim 10, the tray assembly comprising:
a tray panel, wherein the tray panel is extending along the vertical axis when attached to the spine; and
a plurality of tray plates releasably attachable to the tray panel.

12. The fiber optic closure of claim 11, the tray panel forming a slot, the slot receivable at the tray retention member at the spine.

13. The fiber optic closure of claim 1, the closure comprising:
a routing panel attachable to the spine, the routing panel forming a passage below the platform along the vertical axis, the passage extending along the lateral axis.

14. The fiber optic closure of claim 13, the routing panel comprising:
a routing panel spool extending along the lateral axis.

15. The fiber optic closure of claim 13, the closure comprising:
a tube holder attachable to the routing panel, the tube holder forming a channel extending along the vertical axis.

16. The fiber optic closure of claim 1, the closure comprising:
an upper routing guide comprising a wall forming a passageway extending along the lateral axis, the upper routing guide positioned at a second end of the closure.

17. A fiber optic closure, wherein a reference coordinate system defines a mutually orthogonal vertical axis, lateral axis, and transverse axis, the closure comprising:
a spine extending along the vertical axis, the spine forming a first wall extending along the transverse axis, the first wall comprising a first face and a second face each extending along the transverse axis and the vertical axis, the first face and the second face each positioned opposite of one another along the lateral axis, the spine forming a second wall extending along the lateral axis, the second wall comprising a third face and a fourth face each extending along the lateral axis and the vertical axis, the third face and the fourth face each positioned opposite of one another along the transverse axis;
a platform, the platform releasably attachable to the spine at each of the third face and the fourth face, the platform configured to extend in a first position alongside the second wall along the vertical axis, the platform configured to extend in a second position at an angle from second wall between the vertical axis and the transverse axis; and
a plurality of tray assemblies releasably attachable to the first face and the second face of the spine, the plurality of tray assemblies attachable to the spine in adjacent arrangement along the vertical axis at the first face and the second face, each tray assembly comprising a tray panel extending along the vertical axis when attached to the spine, wherein a plurality of tray plates is releasably attachable to the tray panel.

18. The fiber optic closure of claim 17, the closure comprising:
a hinge interface rotatably coupling the platform to the spine at the second wall.

19. The fiber optic closure of claim 17, the spine comprising a tray retention member positioned in a track formed by the spine, the tray retention member configured to releasably attach the tray assembly to the spine.

20. The fiber optic closure of claim 17, the closure comprising:
a flexible member coupled to the platform and the second wall at the spine and the platform, the flexible member configured to retain the platform at the angle in the second position.
